(19) United States
(12) Patent Application Publication
(10) Pub. No.: US 2023/0331995 A1
(43) Pub. Date: Oct. 19, 2023

(54) MATERIALS, METHODS, DEVICES AND SYSTEMS FOR INSULATING CAVITIES OF BUILDINGS WITH FOAM INSULATION

(71) Applicant: CertainTeed LLC, Malvern, PA (US)

(72) Inventors: Nicholas Orf, Natick, MA (US); Rachel Brown, Shrewsbury, MA (US); Sizhu You, Auburndale, MA (US); Brian ` Fogg, Rochester Hills, MI (US)

(21) Appl. No.: 18/043,098

(22) PCT Filed: Aug. 26, 2021
(86) PCT No.: PCT/US2021/047716

§ 371 Date: Feb. 27, 2023

Related U.S. Application Data
(60) Provisional application No. 63/071,294, filed on Aug. 27, 2020.
(60) Provisional application No. 63/071,292, filed on Aug. 27, 2020.

(51) Int. Cl. C09D 5/02; C09D 7/40; C09D 175/02; C09D 7/61; E04B 1/76; C09D 7/63; C09D 175/04; C09D 5/18

(52) U.S. Cl. CPC C09D 5/021; C09D 5/18; C09D 7/61; C09D 7/63; C09D 7/67; C09D 7/68; C09D 175/02; C09D 175/04; E04B 1/7604

(57) ABSTRACT

The present disclosure relates generally to methods, devices and systems for insulation, e.g., of cavities associated with walls, ceilings, floors and other building structures, with foam insulation. In one aspect, the disclosure provides an expanding foam insulation material, the expanding foam insulation material being dispensable and expandable to provide an expanding foam insulation material having a maximum foam height; and no local pressure maximum of more than 500 Pa, wherein for each local pressure maximum in excess of 50 Pa, a time difference between a time of the local pressure maximum and a time of 95% maximum foam height is no more than 80 seconds. The expanding foam insulation material is desirably provided with Class A fire rating.

### CROSS-REFERENCE TO RELATED APPLICATIONS

This application claims the benefit of priority of U.S. Provisional Pat. Applications nos. 63/071292 and 63/071294, each filed on Aug. 27, 2020, each of which is hereby incorporated herein by reference in its entirety.

### BACKGROUND OF THE DISCLOSURE

### 1. Field of the Disclosure

The present disclosure relates generally to materials, methods, devices and systems for insulation, e.g., of cavities associated with walls, ceilings, floors and other building structures. More particularly, the present disclosure relates to materials, methods, devices and systems for insulation with foam insulation, such as expanding foam insulation.

### 2. Technical Background

Heating and cooling of buildings uses approximately 35% of all the energy consumed in the United States of America (USA). Thanks to numerous innovations in construction practices and materials used in new construction, new buildings use less than half the energy per square foot of older buildings. However, the number of new buildings built each year is only about 2% of the number of existing buildings. Since most buildings last for 50 years or more, it will take several generations before low energy new buildings begin to have a significant impact on the overall energy used by buildings in the USA. Thus there is an urgent national need for simple low cost retrofit energy saving technologies that can be applied to existing buildings to achieve energy use similar to new buildings.

The most common approach to reduce thermal energy use in existing buildings is “weatherization”. In a typical weatherization job, a contractor seals air leaks and adds additional blown in fibrous insulation to the attic of a building. Federal and state governments have invested billions of dollars in weatherization programs. However, most studies indicate that weatherization projects result in average energy savings of only 15% and don’t come close to achieving the energy use levels of new buildings. A recent study of weatherization programs, conducted by MIT, the University of Chicago, and the University of California, concluded that the average annual return on government funded weatherization programs is -9%.

Another approach for reducing thermal energy use in buildings is a “deep energy retrofit”. As opposed to the 15% energy savings of a weatherization job, a deep energy retrofit of a building can reduce the thermal energy use by 30%-50% or more. Typical deep energy retrofits involve tearing off siding, resetting windows, reconfiguring roof eaves, fitting foam boards to the exteriors of the building, and replacing the siding. Because of the invasiveness of this process, the cost and time involved is very high. Typical time to complete a deep energy retrofit of a house is several months and often requires building occupants to vacate the building. Typical payback time is 25 years or more. Traditional deep energy retrofits are clearly not viable on a large scale.

Typical insulating materials used in building insulations include solid rigid foam insulating boards, fibrous insulation, and spray or injection foams. Rigid foam insulating boards are composed of small, individual cells separated from each other. The cellular material may be glass or foamed plastic, such as polystyrene, polyurethane, polyisocyanurate, polyolefin, and various elastomeric materials. Fibrous insulation is composed of small-diameter fibers, which finely divide the air space. Examples of fibrous insulation include fiberglass and mineral wool type insulations. Foam-in place insulation includes liquid foams that are sprayed, injected, or poured in place. In one example, spray or injection polyurethane foams a two-component mixture composed of isocyanate and polyol resin are mixed near the tip of a gun. The two most common methods of mixing are impingement mixing (a “high pressure” system), in which two streams of material impact each other under high pressure and static mixing (a “low pressure” system), in which the two streams of material are interlaced using a series of mixing elements. After ejection from the gun, the mixed partially expanded material forms an expanding foam that is sprayed onto roof tiles, concrete slabs, into wall cavities, or through holes drilled into a cavity of a finished wall. Once in place, the mixed foam fully expands. In closed-cell foam, the high-density cells are closed and filled with a gas that both enhances insulation value and helps the foam expand to fill the spaces around it. Open-cell foam cells are not as dense as the closed-cell foams and are filled with air, which gives the insulation a spongier texture.

Injection of open or closed cell foam into cavities within a building can achieve many of the same benefits of a traditional deep energy retrofit at costs that are at least an order of magnitude lower-and in days rather than months. Closed cell foam in particular offers many advantages over traditional fiberglass or cellulose insulation since it has twice the insulation value per inch and serves as both an air barrier and vapor barrier. Energy models of a house injected with closed cell foam indicate that thermal energy savings of 30%-50% can be achieved. A typical house can be injected in 3 days and the modeled payback time is 5 years or less.

In a typical liquid foam injection process, 4 or more holes are drilled on the interior or exterior of each cavity within the building, and then a 6″ tube is inserted into these holes and a shot of foam is injected and falls to the bottom of the cavity. After the foam has fully expanded and is tack free, a second shot can be injected above the first shot. Each layer of foam is called a “lift”. A typical 14.5″ wide×8′ high cavity is filled with 3 to 4 lifts of foam. As the foam cures within the cavity, it heats up in an exothermic reaction. Heated foam can be easily seen from the outside of the cavity with an infrared camera, and voids within the foam can be identified and corrected with additional shots of foam.

Despite its tremendous potential, injection foam is rarely practiced. One of the main issues is concern about the expanding foam “blowing out” walls. Typical closed cell injection foam, known as “pour foam”, expands 30 times its liquid volume. This significant expansion combined with a compressive strength of 25 psi or more can easily cause existing plaster or drywall to bow out or completely detach from the framing.

Some insulation workers have tried to address this issue by using foams that only expand 3 to 5 times their dispensed volume. These foams, known as “froth foams”, contain gaseous blowing agent or a mixture of gaseous and liquid blowing agents. While froth foams are generally preferred over pour foams, the packaging, metering and mixing of froth foams is problematic. Due to the gaseous blowing agent, froth foams are packaged in pressure vessels. Foam in disposable pressure vessels are expensive to package and ship-costing about twice as much as two component pour foams-and have inadequate control over dispensed volume and mixing. Re-usable pressure vessels are heavy, can’t easily be moved around inside a building, and are exceedingly difficult for manufacturers to track. Metering of non-froth foams can be equally, or even more challenging.

An additional method of addressing the blow out issue is to drill multiple pressure relief holes, often of 1″ diameter or more. Any excess foam flows out of these pressure relief holes to avoid pressure buildup on the walls of the cavity. However, large holes require extensive repair and repainting of the interior or exterior of the wall cavity.

What is needed is improved materials, methods, devices and systems for insulating building cavities with foam insulation.

### SUMMARY OF THE DISCLOSURE

In one aspect, the present disclosure provides an expanding foam insulation material, the expanding foam insulation material being dispensable and expandable to provide an expanded foam insulation material, the expanding foam insulation material having a maximum foam height; and no local pressure maximum of more than 500 Pa, wherein for each local pressure maximum in excess of 50 Pa, a time difference between a time of the local pressure maximum and a time of 95% maximum foam height is no more than 80 seconds. In another aspect, the present disclosure provides an expanding foam insulation material, the expanding foam insulation material being dispensable and expandable to provide an expanded foam insulation material, the expanding foam insulation material having a maximum foam height; for a local pressure maximum after a time of maximum foam height, a time difference between a time of the local pressure maximum and a time of 95% maximum foam height is no more than 80 seconds. The present inventors have determined that such foam insulation materials have an unexpectedly low risk of blowing out walls.

In another aspect, the present disclosure provides an expanding foam insulation material (for example, an expanding foam material as described in the paragraph immediately above or any of the embodiments herein), the expanding foam insulation material being dispensable and expandable to provide an expanded foam insulation material, wherein
(a) the expanding foam insulation material is a polymerizable composition comprising at least one polyol and at least one polyisocyanate, and the expanded foam insulation material is a polyurethane;
(b) the expanding foam insulation material is a polymerizable composition comprising at least one polyamine and at least one polyisocyanate, and the expanded foam insulation material is a polyurea; or
(c) the expanding foam insulation material is a polymerizable composition comprising at least one polyol, at least one polyamine and at least one polyisocyanate, and the expanded foam insulation material is a mixed polyurethane/polyurea; and
   (i) the polyisocyanate component has a polyisocyanate functionality of no more than 2.6, e.g., in the range of 1.9-2.6, or 2.0-2.6, or 2.1-2.6;
   (ii) the polyol and/or polyamine component has a polyol and/or polyamine functionality of no more than 3.5, e.g., in the range of 1.9-3.5, or 2.0-3.5, or 2.1-3.5; and/or
   (iii) the iso index of the polymerizable composition is no more than 200, e.g., in the range of 80-200, or 90-200, or 100-200.

In another aspect, the present disclosure provides method for providing a cavity of a building with an expanded foam insulation (e.g., as described herein), the cavity having a first wall, the method comprising performing one or more dispensing shots (e.g., discrete dispensing shots), each comprising dispensing an amount of the expanding foam insulation as described herein into the cavity; and then allowing the dispensed amount of expanding foam insulation to substantially expand after it is dispensed in the cavity, thereby forming a shot of expanded foam insulation in the cavity.

Another aspect of the disclosure is a method for providing a cavity of a building with a predetermined amount of expanding foam insulation (e.g., as described herein), the cavity having a first wall, the method comprising
actuating a valve (e.g., of an insulation dispenser) to begin dispensing expanding foam insulation (e.g., from the insulation dispenser) into the cavity, the actuation being performed by a user, the actuation by the user fixing a start time and/or a zero volume of a time and/or volume meter; then,
dispensing the expanding foam insulation (e.g., from the insulation dispenser) into the cavity as the time and/or volume meter counts time and/or volume dispensed; then
when a predetermined time after the start time elapses or a predetermined volume of the expanding foam insulation beyond the zero volume is dispensed as measured by the time and/or volume meter, actuating the valve to stop dispensing the expanding foam insulation into the cavity.

In another aspect, the present disclosure provides an insulation dispenser comprising:
a body having one or more input ports and an output port
one or more valves, each configured to control fluid communication between one or more of the input ports and the output port such that fluid communication being allowed when the valve(s) are open and fluid communication not being allowed when the valve(s) are closed;
a user-actuatable actuator configured to actuate the one or more valves;
wherein the insulation dispenser is configured to fix a start time and/or a zero volume of a time and/or volume meter upon actuation of the actuator by a user.

The methods of the disclosure can be performed using a dispenser according to this aspect of the disclosure, or a system including such a dispenser.

Another aspect of the disclosure is a kit for the production of an expanding insulating foam as described herein, the kit including a plurality of containers (e.g., two), each container including one or more components of the expanding foam insulation but neither container containing all the components of the expanding foam insulation. Expanding insulating foam materials of the disclosure can be made, for example, by mixing together a plurality of streams of material, one stream from each of the plurality of containers.

Additional aspects of the disclosure will be evident from the disclosure herein.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a schematic cross-sectional view of the dispensing of foam insulation into a cavity at least partially enclosed by one or more walls according to one embodiment of the disclosure.

FIG. 2 is a schematic view of an insulation dispenser in the form of an insulation dispenser gun according to one embodiment of the disclosure.

FIG. 3 is a schematic view of an insulation dispenser in the form of an insulation dispenser gun according to another embodiment of the disclosure.

FIG. 4 is a schematic view of an insulation dispenser in the form of an insulation dispenser gun according to another embodiment of the disclosure.

FIGS. 5 and 6 are schematic views of insulation dispensing systems according to other embodiments of the disclosure.

FIG. 7 is a schematic view of an indicator display according to one embodiment of the disclosure.

FIG. 8 is a schematic view of an indicator display according to one embodiment of the disclosure.

FIG. 9 is a schematic view of an indicator display according to one embodiment of the disclosure.

FIGS. 10 and 11 are schematic views of an insulation dispensing system according to one embodiment of the disclosure.

FIG. 12 is a schematic view of an insulation system according to one embodiment of the disclosure.

FIG. 13 is a schematic view of an insulation dispenser in the form of an insulation dispenser gun according to another embodiment of the disclosure.

FIG. 14 is a schematic view of an insulation dispenser in the form of an insulation dispenser gun according to another embodiment of the disclosure.

FIG. 15 is a picture and a schematic view of a FOAMAT® Foam Qualification System.

FIGS. 16-19 are graphs of kinetic parameter data for various expanding foams.

FIG. 20 is a graph comparing kinetic parameter data for three expanding foams.

FIG. 21 is a graph comparing experimental results for various polyurethane foams of the disclosure.

### DETAILED DESCRIPTION

The present inventors have noted that while processes for injecting expanding foam insulation into enclosed building cavities have previously existed, they suffered from a risk of “blow-out,” that is, the pressure caused by the expansion of the foam causing a wallboard to bow out, to become disconnected from the framing structure, or even to break. While slow-rising froth foams have been proposed as a solution to this problem, the solution has turned out to be only partial. The present inventors have unexpectedly determined that expanding insulating foams having a certain combination of kinetic parameters have a significantly reduced risk of blow-out. Accordingly, in certain aspects, the expanding foam insulation material has a maximum foam height; and no local pressure maximum of no more than 500 Pa, wherein for each local pressure maximum in excess of 50 Pa, a time difference between a time of the local pressure maximum and a time of 95% maximum foam height is no more than 80 seconds.

Without intending to be bound by theory, the inventors surmise that pressure buildup before the time of peak rise is acceptable, because the foam is able to continue expanding. But when the foam reaches its peak rise, believed to be in the neighborhood of (e.g., shortly after) the gel point of the material, this mechanism for pressure relief no longer exists, and so pressure build after this point exerts itself most strongly on the wall(s) of the cavity. Accordingly, design and use of materials with such characteristics together with other desirable characteristics for use as building insulation materials (e.g., in some embodiments, flame resistance) can provide for improved installation and use of expanding foam insulation materials.

Moreover, conventional methods for installation of foam insulations were disadvantaged by the risks of under- or over-filling the cavity, as there have not conventionally been ways to properly meter the amount of foam insulation entering the cavity. The present disclosure provides, in certain embodiments, a number of ways to control the amount of foam insulation being dispensed into a cavity, e.g., based on time and/or volume metering. In some embodiments, such metering can be performed through directing a user to when to stop dispensing foam through an insulation dispenser. In other embodiments, direct control of the amount of foam insulation is performed (e.g., through electronic control of one or more valves.

In one aspect, the disclosure provides an expanding foam insulation material, the expanding foam insulation material being dispensable and expandable to provide an expanded foam insulation material, the expanding foam insulation material having a maximum foam height; and a final peak pressure of no more than 500 Pa, wherein for each local pressure maximum in excess of 50 Pa, a time difference between a time of the local pressure maximum and a time of 95% maximum foam height is no more than 80 seconds. In another aspect, the present disclosure provides an expanding foam insulation material, the expanding foam insulation material being dispensable and expandable to provide an expanded foam insulation material, the expanding foam insulation material having a maximum foam height; for a pressure maximum after a time of maximum foam height, a time difference between a time of the pressure maximum and a time of 95% maximum foam height is no more than 80 seconds. Expanding foam insulation materials are generally known in the art, and can be adapted based on the present disclosure to provide materials having the kinetic parameters and other properties as described herein.

Such materials are typically based on polyurethane foams, formed from mixing an “A” component (typically including at least one polyisocyanate (i.e., bearing more than one reactive isocyanate moiety) and a “B” component (typically including at least one polyol (i.e., bearing more than one reactive alcohol moiety)). But in certain embodiments of the disclosure, materials are based on polyurea foams, formed from mixing an “A” component (typically including at least one polyisocyanate (i.e., bearing more than one reactive isocyanate moiety) and a “B” component (typically including at least one polyamine (i.e., bearing more than one reactive amine moiety)). And in other embodiments of the disclosure, materials are based on mixed polyurethane/polyurea foams, formed from mixing an “A” component (typically including at least one polyisocyanate (i.e., bearing more than one reactive isocyanate moiety) and a “B” component (typically including at least one polyol (i.e., bearing more than one reactive alcohol moiety) and at least one polyamine (i.e., bearing more than one reactive amine moiety)).

Thus, in certain desirable embodiments, the expanded foam insulation material is a polyurethane that is a reaction product of a polymerizable composition including least one polyol and at least one polyisocyanate, i.e., it is a polyurethane having at least one polyol and at least one polyisocyanate as fundamental monomeric units. It will be appreciated that materials actually provided as part of the expanding foam (e.g., in a plurality of containers to be mixed together at the time of dispensing) are oligomeric or prepolymeric in nature. A variety of polyols can be used in the polyurethane foams of the disclosure. In certain embodiments, the at least one polyol includes at least one polyether polyol (e.g., a polyethylene oxide / polypropylene oxide polyol) and/or at least one polyester polyol (e.g., aromatic or aliphatic). Other polyols can be used, e.g., sugar or sugar alcohol-based polyols like alkoxylated sorbitols and alkoxylated sucroses, and natural oil-based polyols such as ricinoleic triglycerides and alkoxylated versions thereof. For example, in certain embodiments as otherwise described herein, the at least one polyol includes a polycarbonate polyol. The polycarbonate polyol(s) can provide all of the polyol of the material, or in other embodiments can be present in the polyurethane material with other polyols (e.g., polyether polyols, polyester polyols). Polycarbonate polyols can help improve the fire performance of a polyurethane foam insulation material, e.g., by making the foam burn more “cleanly” and thus provide a lower smoke index.

Similarly, a variety of polyisocyanates can be used in the polyurethane foams of the disclosure. In certain embodiments, the at least one the at least one polyisocyanate includes toluene diisocyanate (TDI) or methylene diphenyl diisocyanate (MDI). Both polyols and polyisocyanates can be provided in oligomeric form, e.g., a reaction product of an excess of polyol with polyisocyanate to provide a polyol-functional oligomer, or a reaction product of an excess of polyisocyanate with polyol to provide an polyisocyanate-functional oligomer. Polymeric forms of isocyanates, e.g., polymeric MDI can also be used.

In other embodiments, the expanded foam insulation material is a polyurea that is a reaction product of a polymerizable composition comprising at least one polyamine and at least one polyisocyanate. Combinations of polyols and polyamines can also be used to provide mixed polyurethane/polyurea-based materials, and so in other embodiments the expanded foam insulation material is a mixed polyurethane/polyurea that is a reaction product of a polymerizable composition comprising at least one polyol, at least one polyamine and at least one polyisocyanate. A variety of polyamines can be used in such polymerizable compositions, including aminated versions of the polyols described above. The polyisocyanate and, when present, polyol component(s) can be as described above.

A blowing agent (gas, or a material that will evolve gas) is typically used to foam and expand the A+B reaction product; hydrofluorocarbon (e.g., hydrofluoroolefin) is one example. As used herein, an “expanding” foam material is one that expands to at least 120% of its as-dispensed volume after it is dispensed in a cavity. In certain embodiments, the expanding material used in conjunction with the methods, devices and systems described herein expand to at least two times its as-dispensed volume after it is dispensed in a cavity, e.g., 2-5 times. Reference herein to a material as “expanded” relates to the material after it is in its final, expanded state.

Pressure, foam height, shrinkage, foam temperature and timing thereof are measured using a FOAMAT® Foam Qualification System at room temperature. 100 grams of expanding foam is dispensed (dispense pressure ~100 psi) into a 6″ cardboard cylinder and placed under the ultrasonic sensor of the Foam Qualification System, and data are collected from the ultrasonic sensor (foam rise height), the pressure sensor at the bottom of the cylinder (pressure), and thermocouple (temperature, metal-sheathed, 1/8″ OD thermocouple) inserted into the foam core. The foaming reaction is then monitored for at least 300 seconds.

The maximum foam height is determined as the maximum height of the foam achieved during the 300 seconds of measurement in the FOAMAT® Foam Qualification System.

In certain aspects, the expanding foam insulation material has no local pressure maximum of more than 500 Pa. As used herein, the local pressure maximum is a local maximum in pressure that occurs during the 300 seconds of measurement in the FOAMAT® Foam Qualification System that is in excess of 50 Pa in pressure. Without intending to be bound by theory, the inventors believe that a relatively low pressure maximum can help to prevent blow-out. In certain embodiments as otherwise described herein, the expanding foam insulation material has no local pressure maxima of more than 300 Pa, or even no local pressure maxima of more than 250 Pa. For example, in certain embodiments, the expanding foam insulation material has a highest local pressure maximum in the range of 50-500 Pa, e.g., 100-500 Pa. In certain embodiments, the expanding foam insulation material has a highest local pressure maximum in the range of 50-300 Pa, e.g., 100-300 Pa, or 50-250 Pa, or 100-250 Pa.

But the present inventors have determined that low local pressure maxima in many cases are not sufficient to prevent blow-out. Rather, the present inventors have determined that blow-out risk is significantly reduced when for each local pressure maximum in excess of 50 Pa, a time difference between a time of the local pressure maximum and a time of 95% maximum foam height is no more than 80 seconds. The time of 95% maximum foam height is the earliest time during the 300 seconds of measurement in the FOAMAT® Foam Qualification System at which the foam height reaches 95% of its maximum value. In certain desirable embodiments, for each local pressure maximum in excess of 50 Pa, a time difference between a time of the local pressure maximum and a time of 95% maximum foam height is no more than 75 seconds, e.g., no more than 70 seconds. In certain desirable embodiments, for each local pressure maximum in excess of 50 Pa, a time difference between a time of the local pressure maximum and a time of 95% maximum foam height is no more than 65 seconds, e.g., no more than 60 seconds. In certain desirable embodiments, for each local pressure maximum in excess of 50 Pa, a time difference between a time of the local pressure maximum and a time of 95% maximum foam height is no more no more than 50 seconds, e.g., no more than 40 seconds. In certain desirable embodiments, for each local pressure maximum in excess of 50 Pa, a time difference between a time of the local pressure maximum and a time of 95% maximum foam height is no more no more than 30 seconds, e.g., no more than 20 seconds.

Similarly, the present inventors have determined that blow-out risk is significantly reduced when for a pressure maximum after a time of maximum foam height, a time difference between a time of the pressure maximum and a time of 95% maximum foam height is no more than 80 seconds. In certain desirable embodiments, a time difference between a time of the pressure maximum and a time of 95% maximum foam height is no more than 75 seconds, e.g., no more than 70 seconds. In certain desirable embodiments, a time difference between a time of the pressure maximum and a time of 95% maximum foam height is no more than 65 seconds, e.g., no more than 60 seconds. In certain desirable embodiments, a time difference between a time of the pressure maximum and a time of 95% maximum foam height is no more than 50 seconds, e.g., no more than 40 seconds. In certain desirable embodiments, a time difference between a time of the pressure maximum and a time of 95% maximum foam height is no more than 30 seconds, e.g., no more than 20 seconds. In certain desirable embodiments, a time difference between a time of the pressure maximum and a time of 95% maximum foam height is no more than 30 seconds, e.g., no more than 20 seconds. In certain desirable embodiments, a time difference between a time of the pressure maximum and a time of 95% maximum foam height is no more than 10 seconds, e.g., no more than 5 seconds.

The person of ordinary skill in the art can provide such materials, e.g., using the formulations and techniques described herein.

While the expansion of the foam will typically take some time to occur, in certain desirable embodiments the time of 95% maximum foam height is no more than 4 minutes, e.g., no more than 3 minutes. However, it can be desirable for the foam not to expand instantaneously; in certain embodiments, the time of 95% maximum foam height is at least 20 seconds, e.g., at least 40 seconds.

Desirable expanding foam insulation materials have a relatively low shrinkage from the maximum foam height. For example, in certain desirable embodiments, an expanding foam insulation as otherwise described herein has a shrinkage after five minutes (i.e., from the time of dispensing, measured as a percentage of maximum height in the FOAMAT® testing described herein) of no more than 5%.

It can be desirable for the temperature in the expanding and curing foam not to get too high. In certain embodiments, the internal temperature of the foam is no more than 120° C., e.g., no more than 100° C. or no more than 80° C. Without intending to be bound by theory, it is believed that lower temperatures during expansion and curing can provide lower internal pressure, and thus provide a lower risk of blow-out.

The kinetic parameters described herein are not the only requirements for a foam insulation material, of course. In certain embodiments, it can be desirable for an expanding foam insulation material to have good fire performance. For example, in certain embodiments, an expanded foam insulation material as otherwise described herein has a flame spread less than 25 at a thickness of 4″ as measured by ASTM E84. And in certain embodiments, an expanded foam insulation material as otherwise described herein has a smoke index less than 450 at a thickness of 4″ as measured by ASTM E84. These two parameters together make up the so-called “Class A” fire rating of ASTM E84.

In certain desirable embodiments, especially for use in various dispensing methods as described herein, it can be desirable for the volume of expanded foam insulation material to be relatively linear with the mass of the dispensed expanding foam insulation material. For example, in certain embodiments, for a volume of expanded foam insulation material over the range of 1000 cm³ to 100000 cm³, the volume of expanded foam insulation material does not deviate from a linear relationship with the mass of expanding foam insulation material by more than 15%, e.g., does not deviate by more than 10%.

The present inventors have noted that providing a material with desirable kinetic parameters as described herein together with such desirable fire properties is a challenging problem, but have identified a number of ways for doing so. Based on the disclosure hereinbelow, the person of ordinary skill in the art will provide a material having the desirable kinetic parameters together with good fire performance.

In certain embodiments as otherwise described herein, the expanding foam insulation material is a polyurethane material having an iso index in the range of 80-450, e.g., 85-400 or 90-300. The iso index of a polyurethane material is the ratio of isocyanate moieties (or reaction products thereof) to alcohol moieties (or reaction products thereof) in the expandable material, expressed as a percentage. An excess of isocyanate allows the formation of cyclic isocyanurate groups via reaction of three isocyanates. Isocyanurate groups can help improve the fire performance of a polyurethane foam insulation material. Accordingly, in certain embodiments as otherwise described herein, the expanding foam insulation material is a polyurethane material having an iso index in the range of 100-450, e.g., 100-350 or 100-250. In certain embodiments, the expanding foam insulation material is a polyurethane material having an iso index in the range of 110-450, e.g., 110-350, or 110-250, or 125-450 or 125-350 or 125-250. Polymeric methylene diphenyl isocyanate can be used to provide isocyanurate groups.

Similarly, polyureas and mixed polyurethane/urea materials can be used. In such cases, the iso index is the ratio of isocyanate moieties (or reaction products thereof) to alcohol and amine moieties (or reaction products thereof) in the expandable material, expressed as a percentage.

The present inventors have determined particular parameters for polyurethane and/or polyurea reaction mixtures that can provide for advantageous pressure vs. rise performance as described herein. The present inventors have unexpectedly found that by selecting a) a particular degree of functionality of the polyisocyanate component; b) a particular degree of functionality of the polyol and/or polyamine component, and c) a particular iso index based on the teachings herein, the gelation of the material can be delayed, such that there is relatively less pressure buildup after the material gels.

As the person of ordinary skill in the art, the functionality of a polyol, polyamine or polyisocyanate of a polymerizable mixture is the number of reactive functionalities per such molecule. As used herein, functionality of each molecule type is considered with respect to a “component,” i.e., as an average number of such functionalities per molecule of that type. Accordingly, the functionality of the polyol component is the average number of —OHgroups per polyol molecule, taken over all polyol molecules. The functionality of a polyamine component is the average number of reactive amines (e.g., of —NH₂ groups) per polyamine molecule taken over all polyamine molecules . The polyol and/or polyamine functionality of the polyol and/or polyamine component used in making a mixed material is the average of the sum of —NH₂ and —OH groups per polyol/polyamine molecule taken over all polyol and polyamine molecules (and any mixed alcohol amine molecules). And the functionality of an polyisocyanate component is the average number of —NCO groups per polyisocyanate molecule, taken over all polyisocyanate molecules.

Accordingly, in certain embodiments as otherwise described herein, the polyisocyanate component has a functionality of no more than 2.6, e.g., in the range of 1.9-2.6, or 2.0-2.6, or 2.1-2.6. In certain embodiments, the polyisocyanate component has a functionality of no more than 2.5, e.g., in the range of 1.9-2.5, or 2.0-2.5, or 2.1-2.5. In certain embodiments, the polyisocyanate has a functionality of no more than 2.4, e.g., in the range of 1.9-2.4, or 2.0-2.4, or 2.1-2.4. In certain embodiments, the polyisocyanate component has a functionality of no more than 2.3, e.g., in the range of 1.9-2.3, or 2.0-2.3, or 2.1-2.3. In certain embodiments, the polyisocyanate component has a functionality of no more than 2.2, e.g., in the range of 1.9-2.2, or 2.0-2.2. As described in the Examples below, the present inventors have determined that reducing the polyisocyanate functionality can help provide for relatively less pressure buildup after gelation. In certain such embodiments, the polyol and/or polyamine functionality of the polyol/polyamine component is in the range of 1.9-5.0, e.g. 1.9-4.0, or 1.9-3.8, or 1.9-3.5, or 1.9-3.0, or 1.9-2.7.

Similarly, in certain embodiments as otherwise described herein, the polyol and/or polyamine component has a polyol and/or polyamine functionality of no more than 3.5, e.g., in the range of 1.9-3.5, or 2.0-3.5, or 2.1-3.5. In certain embodiments, the polyol and/or polyamine component has a polyol and/or polyamine functionality of no more than 3.2, e.g., in the range of 1.9-3.2, or 2.0-3.2, or 2.1-3.2. In certain embodiments, the polyol and/or polyamine component has a polyol and/or polyamine functionality of no more than 3.0, e.g., in the range of 1.9-3.0, or 2.0-3.0, or 2.1-3.0. In certain embodiments, the polyol and/or polyamine component has a polyol and/or polyamine functionality of no more than 2.4, e.g., in the range of 1.9-2.8, or 2.0-2.8, or 2.1-2.8. In certain embodiments, the polyol and/or polyamine component has a polyol and/or polyamine functionality of no more than 2.4, e.g., in the range of 1.9-2.6, or 2.0-2.6, or 2.1-2.6. In certain embodiments, the polyol and/or polyamine component has a polyol and/or polyamine functionality of no more than 2.4, e.g., in the range of 1.9-2.5, or 2.0-2.5, or 2.1-2.5. In certain embodiments, the polyol and/or polyamine component has a polyol and/or polyamine functionality of no more than 2.4, e.g., in the range of 1.9-2.4, or 2.0-2.4, or 2.1-2.4. In certain embodiments, the polyol and/or polyamine component has a polyol and/or polyamine functionality of no more than 2.3, e.g., in the range of 1.9-2.3, or 2.0-2.3, or 2.1-2.3. In certain embodiments, the polyol and/or polyamine component has a polyol and/or polyamine functionality of no more than 2.2, e.g., in the range of 1.9-2.2, or 2.0-2.2. When the material is a polyurethane, this is a polyol functionality, and when the material is a polyurea, this is a polyamine functionality. As described in the Examples below, the present inventors have determined that reducing the polyol and/or polyamine functionality can help provide for relatively less pressure buildup after gelation. In certain such embodiments, the functionality of the polyisocyanate component is in the range of 1.9-3.0, e.g. 1.9-2.9, or 1.9-2.8, or 1.9-2.7. And in other embodiments, the functionality of the polyisocyanate component is no more than 2.6, e.g., any of the ranges described above with respect to polyisocyanate components of reduced functionality.

The present inventors have determined that one prime reason for wall blowout in the use of expanding foam insulations is the continuing buildup of pressure after the material reaches its gel point. After the gel point, the material can no longer rise within the cavity, and so pressure builds up against the walls, potentially causing failure and wall blowout. Without intending to be bound by theory, the inventors surmise is that this is a result exothermicity after the gel point, which causes pressure buildup in the material, which can only be relieved by material failure. Without intending to be bound by theory, the inventors believe that reducing monomeric functionality will delay the polymeric gel point, which in turn dictates the endpoint of foam expansion/rise in the cavity, to higher degrees of conversion. This means that there is less reaction exothermicity after the gel point, and the correspondingly lower temperature rise results less pressure exerted by the gaseous blowing agent. This results in less pressure being put on the walls of the cavity, and an advantageously lower risk of blowout.

The present inventors have also determined that a relatively low iso index can surprisingly help provide for relatively less pressure buildup after gelation. In certain embodiments as otherwise described herein, the iso index of the polymerizable composition is no more than 200, e.g., in the range of 80-200, or 90-140, or 100-200. In certain embodiments as otherwise described herein, the iso index of the polymerizable composition is no more than 180, e.g., in the range of 80-180, or 90-180, or 100-180. In certain embodiments as otherwise described herein, the iso index of the polymerizable composition is no more than 150, e.g., in the range of 80-150, or 90-150, or 100-150. In certain embodiments as otherwise described herein, the iso index of the polymerizable composition is no more than 140, e.g., in the range of 80-140, or 90-140, or 100-140. In certain embodiments as otherwise described herein, the iso index of the polymerizable composition is no more than 130, e.g., in the range of 80-130, or 90-130, or 100-130. In certain embodiments as otherwise described herein, the iso index of the polymerizable composition is no more than 120, e.g., in the range of 80-120, or 90-120, or 100-120. In certain embodiments as otherwise described herein, the iso index of the polymerizable composition is no more than 110, e.g., in the range of 80-110, or 90-110.

It can also be desirable to formulate materials using particulate fire retardants. For example, in certain embodiments, an expanding foam insulation material includes one or more particulate fire retardants, e.g., selected from melamine polyphosphate, ammonium polyphosphate, and expandable graphite. In certain embodiments, such particulate fire retardants are present in an amount up to 30 wt%, e.g., 1-30 wt%, or 5-20 wt%, or 1-10 wt%, or 5-15 wt%. Throughout this disclosure, wt% values are provided with respect to the total weight of a material. In order to prevent the hard-packing of such particulate fire retardants as they settle over time, it can be desirable to additionally include a hydrophobic silica having a D50 particle size in the range of 10-1000 nm.

Water-containing minerals can also be used to improve the fire resistance of a material as described herein. For example, in certain embodiments, an expanding foam insulation material as otherwise described herein includes one or more water-containing minerals having a dehydratable water content of at least 20 wt%. The dehydratable water is water that will be dehydrated from the mineral at or below a temperature of 400° C. This can be, for example, water bound as water of crystallization (e.g., as in gypsum), or water nominally present as hydroxide (e.g., as in aluminum trihydroxide). And in certain embodiments, an expanding foam insulation material as otherwise described herein includes one or more water-containing minerals having a dehydratable water content, the one or more minerals being selected from aluminum trihydrate (e.g., gibbsite), magnesium dihydrate, gypsum and magnesium carbonate hydrate. The water-containing minerals can in some embodiments be provided with coatings to enhance compatibility with the polymeric material of the foam (e.g., a hydrophobic coating). The water-containing minerals can be present in any suitable amount, such as wherein the one or more water-containing minerals are present in the expanding foam insulation in an amount in the range of 5-60 wt%, e.g., 5-45 wt% or 15-60 wt% or 15-45 wt% or 30-60 wt%.

Halogenated flame retardants can also be used to improve the flame performance of the materials. For example, in certain embodiments as otherwise described herein, one or more halogenated flame retardants are present in the expanding foam insulation material. Examples include, e.g., brominated alcohols such as polybrominated diphenyl ethers, tribromoneopentyl alcohol, tetrabromophthalates (e.g., tetrabromophthalate diol such as PHT4-diol (Great Lakes) and their reaction products; dibromoneopentyl glycol, tribromophenol, and reaction products thereof; chlorinated organophosphates such as tris(1,3-dichloroisopropyl) phosphate, (1-chloro-2-propyl) phosphate, 2,2-bis(chloromethyl)propane-1,3-diyl tetrakis(1-chloropropan-2-yl) bis(phosphate), and tris (2-chloroethyl) phosphate; and chlorinated paraffins. In certain embodiments, the halogenated flame retardant is present in the composition in an amount up to 20 wt%, e.g., 5-20 wt%, or 10-20 wt%. In certain such embodiments, it can be desirable to include antimony trioxide in combination with the halogenated flame retardants, e.g., in an amount in the range of 50% -400% of the weight of the halogenated flame retardant(s), e.g., 100%-300%.

Phosphate-based flame retardants can also be used to improve the fire resistance of the expanding foam insulation materials of the disclosure. In certain embodiments as otherwise described herein, the expanding foam insulation material includes a non-halogenated phosphate flame retardant, e.g., triethyl phosphate (TEP), resorcinol bis(diphenyl phosphate), and phosphate plasticizers. In certain such embodiment, the non-halogenated phosphate flame retardant is present in the expanding foam insulation material in an amount in the range of 0.5 wt% to 20 wt%, e.g., 1-20 wt%, 5-20 wt%, 1-10 wt% or 5-15 wt%.

In certain embodiments, an expanding foam insulation material as otherwise described herein includes a reactive phosphorus-based flame retardant. Examples include polyphosphonate-co-carbonates (e.g., Nofia products from FRX), phosphorus polyols (e.g., OP550 or OP560 from Clariant), alkylphosphate oligomers (e.g., Fyrol PNX from ICL), diethyl (hydroxymethyl) phosphonate, and 9-10-dihydro-9-oxa-10-phosphaphenanthrene-10-oxide (DOPO) and its derivatives. In certain embodiments, the reactive phosphorus-based flame retardant is present in the composition in an amount up to 20 wt%, e.g., 1-20 wt%, or 5-20 wt%, or 10-20 wt%, or 1-10 wt%, or 5-10 wt%, or 1-5 wt%.

The person of ordinary skill in the art, based on the present disclosure, can use one or more of the techniques described herein to provide desirable fire resistance. In certain embodiments, the compositions described herein will include at least 40 wt%, e.g., at least 50 wt%, at least 60 wt% or at least 70 wt% of polyol and polyisocyanate components.

The expanding foam insulation is typically in a partially-expanded state as it is dispensed into the building cavity, where it continues to expand to its final expanded state. However, the person of ordinary skill in the art will appreciate that the expanding foam insulation can be dispensed in a variety of forms. The expanding foam insulation may not yet be substantially expanded, such that it is substantially expanded only in the cavity. For example, precursors can mix in the dispenser to react and begin to expand, so that a partially-expanded foam is what is dispensed into the cavity. Material described herein as “expanding insulation foam” encompasses any set of one or more precursors and/or reaction products thereof that are admitted together to the cavity and form the expanded foam insulation.

Another aspect of the disclosure is an expanded foam material that is the cured reaction product of an expanding foam insulation product as otherwise described herein.

Another aspect of the disclosure is a method for providing a cavity of a building with an expanded foam insulation, the cavity being enclosed by one or more walls including a first wall. The method includes performing one or more dispensing shots. Each dispensing shot includes dispensing an amount of an expanding foam insulation as described herein into the cavity; and then allowing the dispensed amount of expanding foam insulation to substantially expand after it is dispensed in the cavity, thereby forming a shot of expanded foam insulation in the cavity. Each dispensing shot can be any amount of material, e.g., all of the material to be disposed in the cavity, or some fraction thereof.

In certain embodiments of the methods as otherwise described herein, the cavity has a first wall having an aperture formed therein, and wherein the expanding foam insulation is dispensed into the cavity from the insulation dispenser through the aperture. The aperture can be pre-formed, or, in other embodiments, the method can include forming the aperture in the first wall before performing the one or more discrete dispensing shots. The aperture can be patched after dispensing the foam insulation.

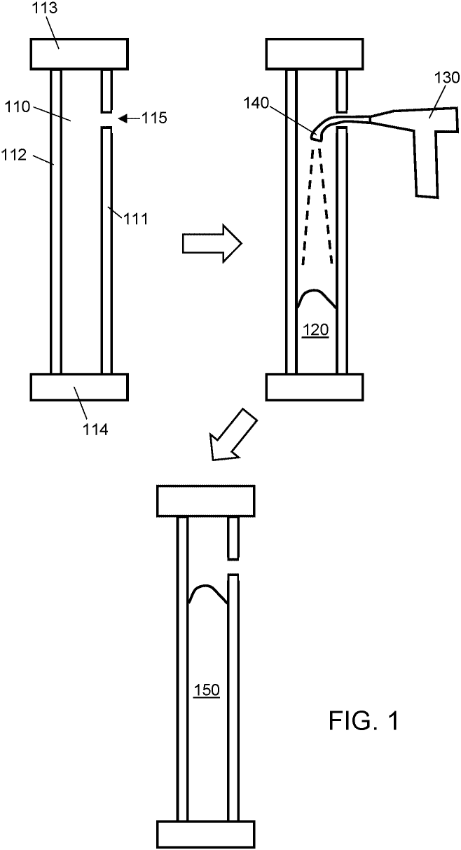

FIG. 1 is a schematic cross-sectional view of one embodiment of a method of dispensing of expanding foam insulation material into a cavity at least partially enclosed by one or more walls. Wall cavity 110 includes a first wall 111, a second wall 112, a third wall 113 and a fourth wall 114, defining a substantially enclosed cavity. Wall cavity 110 can be closed off by two additional walls, e.g., parallel to the plane of the page. As is conventional, these walls can be formed of a variety of materials, e.g., wallboard, lath and plaster, cement, wood, metal, and different materials can be used in different walls of a particular cavity. One or more of the walls enclosing the cavity can be formed from framing members; in the example of FIG. 1, the first and second walls are wallboards and the third and fourth walls are framing members. And the person of ordinary skill in the art can appreciate that different cavities may have different shapes and thus different numbers of walls enclosing them. As used herein, a “substantially enclosed” cavity is enclosed over at least 90%, e.g., at least 95% of its surface area. The cavity can be, for example, a wall cavity, a ceiling cavity, or a floor cavity. The cavity thus need not be entirely enclosed. The person of ordinary skill in the art will appreciate that the methods described herein can be used in the insulation of a wide variety of building cavities. Such cavities can, in some cases, already have fibrous insulation (e.g., fiberglass) disposed therein. Expanding foam insulation material 120 (e.g., in a mixed and partially-expanded stated) is dispensed through an aperture 115 in the first wall 111 into the cavity 110 from an insulation dispenser 130 (often in the form of a “gun”), either directly from the tip of the dispenser or through a tube 135 extending into the cavity. After a volume of partially-expanded expanding foam insulation material 120 is dispensed, it continues to expand to provide fully-expanded foam insulation 125 disposed in the cavity. Often, multiple “shots” of expanding foam insulation material are used to fill the cavity, with the shots of expanded foam insulation being layered on top of one another in the cavity. After the desired amount of material is dispensed and expanded, the aperture can be patched if desired. A number of methods for dispensing expanding foam insulation materials into building cavities are described in U.S. Pat. Application Publication no. 2017/0080614, which is hereby incorporated herein by reference in its entirety. The person of ordinary skill in the art can adapt any of the methods described therein, as well as other methods for dispensing expanding foam insulation material, with the metering methods, devices and systems described here.

Each dispensing shot can be of a desired amount of expanding foam insulation material. For example, in certain embodiments, the last dispensing shot of the multiple discrete dispensing shots is substantially smaller than (e.g., no more than 75 wt% of) the penultimate dispensing shot of the multiple discrete dispensing shots. This can help prevent overfill of the wall. The other dispensing shots can be of a desired amount. For example, in certain embodiments as otherwise described herein, but for the last dispensing shot, the multiple discrete dispensing shots are performed to dispense substantially the same amount of expanding foam insulation (e.g., within 20% of the average, or within 10% of the average).

In one aspect, the disclosure provides a method for providing a cavity (e.g., as described above with respect to FIG. 1) of a building with a predetermined amount of expanded foam insulation material (e.g., in a single “shot.”). The method includes actuating a valve of an insulation dispenser to begin dispensing expanding foam insulation material from the insulation dispenser into the cavity. The actuation of the valve is performed by a user, i.e., the person dispensing the expanding foam insulation material into the cavity. Notably, the actuation of the valve by the user fixes a start time of a start meter, and/or a zero volume of a volume meter (i.e., depending on whether time metering or volume metering is used, as described in more detail below.) The expanding foam insulation material is then dispensed from the insulation dispenser into the cavity, as the time meter counts time and/or the volume meter counts volume. Then, when a predetermined time after the start time elapses as measured by the time meter, or a predetermined volume of the expanding foam insulation material beyond the zero volume is dispensed as measured by the volume meter, the valve is actuated to stop dispensing the expanding foam insulation material. The expanding foam insulation material is then allowed to finish expanding, thereby forming a shot of the expanded foam insulation material in the cavity.

In certain embodiments, the cavity has a first wall having an aperture formed therein, and the expanding foam insulation material is dispensed into the cavity from the insulation dispenser through the aperture. In many common installations, and especially in retrofit installations, it is impractical to access the wall cavity without forming an aperture in a wall thereof. Accordingly, in many embodiments, a method as otherwise described herein includes forming the aperture in the first wall before actuating the valve to begin dispensing. In certain embodiments, the aperture can be patched after dispensing the expanding foam insulation material.

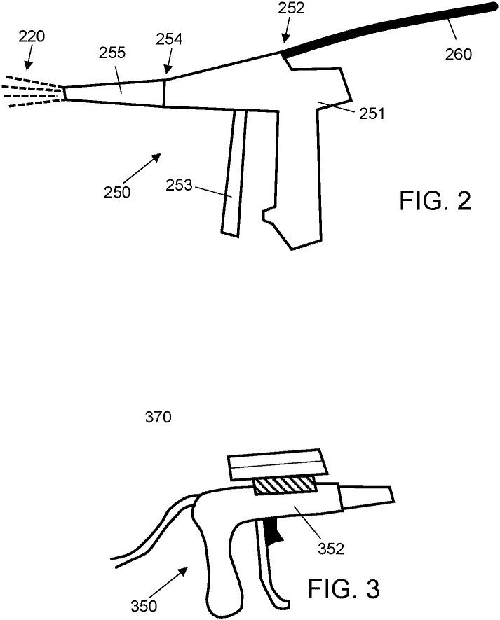

As described above, the user actuates the valve of the insulation dispenser to begin dispensing the expanding foam insulation material. Accordingly, the user can position the insulation dispenser properly with respect to the cavity before beginning the flow of the expanding foam insulation material. The manner in which the user actuates the valve of the insulation dispenser will depend strongly on the design of the insulation dispenser. One example of an insulation dispenser is shown in schematic view in FIG. 2. Insulation dispenser 250 takes the form of a dispensing “gun.” It includes a body 251, which has one or more hoses 260 coupled to the body at one or more input ports 252 thereof to convey a supply of one or more precursors of the expanding foam insulation material. There are often two hoses and two input ports present, one for the “A” component and the other for the “B” component, with the mixing of the reactive mixture happening in the body. The body includes one or more valves (e.g. needle valves, not shown) configured to be opened when the trigger 253 is pulled against the body. While the device of FIG. 2 uses a trigger as the user-actuatable actuator, the person of ordinary skill in the art will appreciate that a variety of other types of actuators can be used, e.g., a button or a switch. The one or more valves control fluid communication between the one or more input ports 252 and output port 254, to which nozzle 255 is coupled, with fluid communication being allowed when the valve(s) are open and fluid communication not being allowed when the valve(s) are closed. Accordingly, when the one or more valves are actuated to begin dispensing by pulling the trigger, the one or more precursors can pass through the body from the one or more hoses 260 to the nozzle 255, from which the expanding foam insulation material 220 can be dispensed. The body can also include a mixing chamber (not shown) in which precursors of the expanding foam insulation material can mix before being conducted to the output port. As the person of ordinary skill in the art will appreciate, various aspects of conventional insulation dispensers can be included in the insulation dispensers described herein, and in many cases conventional insulation dispensers can be adapted to perform as described herein.

As described above, the actuation by the user fixes a start time and/or a zero volume of a time and/or volume meter. Accordingly, it is desirable for the insulation dispenser to be configured to fix a start time and/or a zero volume of a time and/or volume meter upon actuation of the actuator by a user. The manner in which the insulation dispenser fixes the start time and/or zero volume will depend on the details of the system. For example, in embodiments like that described with respect to FIG. 2, an actuation sensor can monitor the actuation state of the trigger, and pass along an appropriate electronic signal to the time and/or volume meter. When the time and/or volume meter is disposed on the insulation dispenser, this can be through a direct electronic interconnection. When the time and/or volume meter is remote to the insulation dispenser, a wireless signal can be used, or a wire interconnecting the insulation dispenser with the insulation dispenser. When the valve is electronically controlled (e.g., with the user pushing an button or switch, which passes a signal to the time and/or volume meter to open the valve), the time and/or volume meter can be in the same electronics as the valve control.

A variety of configurations are available for the time and/or volume meter with respect to the insulation dispenser. For example, in certain embodiments, the time and/or volume meter is mounted on the dispenser itself. Such a configuration is shown in the schematic side view of FIG. 3, in which time and/or volume meter 370 is mounted on the body 352 of the insulation dispenser 350. In such cases, wiring or other interconnection internal to the body can pass a signal to the time and/or volume meter when the user actuates the actuator.

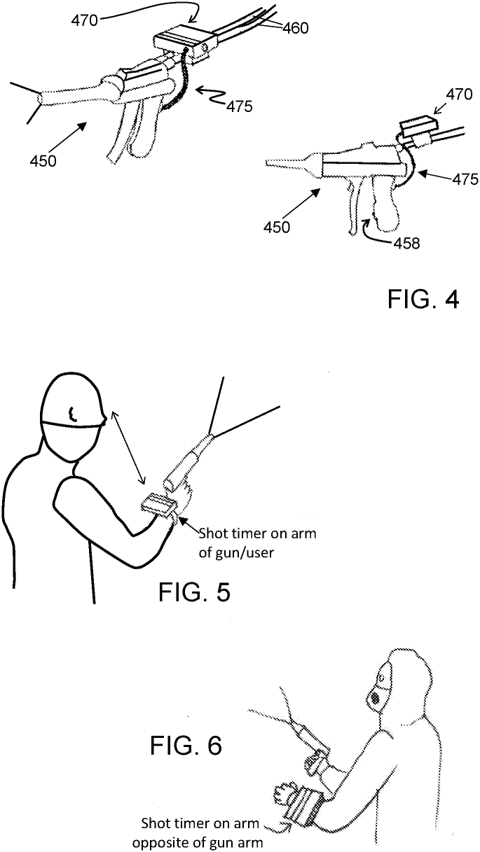

In another embodiment, the time and/or volume meter mounts onto one or more hoses that are operatively connected to the one or more input ports. Such a configuration is shown in the schematic views of FIG. 4. Here, time and/or volume meter 470 is mounted on hoses 460 coupled to input ports of the body 452. An actuation sensor 458 is in the handle portion of the body, such that it can sense when trigger 453 is pulled by a user. In the embodiment of FIG. 4, a wire 475 electronically couples the actuation sensor 458 to the time and/or volume sensor 470, so that an electronic signal can be passed to the time and/or volume meter when the trigger is pulled.

The time and/or volume meter need not be provided on or directly adjacent the insulation dispenser. For example, the time and/or volume meter can be provided as a separate device, with a wireless or wired connection to the insulation dispenser (i.e., to allow for an electronic signal to be passed to the time and/or volume meter when dispensing begins). For example, in certain embodiments, shown in schematic view in FIGS. 5 and 6, the time and/or volume meter can be provided as an arm-mountable device, such that the user can have it on an arm (e.g., on the same arm as is holding the insulation dispenser, or on the other arm). The configuration on the arm can be selected to provide ergonomic and comfortable use in a construction setting while providing feedback to the user and allowing for any desired user input to the meter.

The time and/or volume meter can take a variety of forms. The time and/or volume meter can include appropriate electronics to gather and process any necessary data, perform the desired tracking of time and/or volume, and display any desired information to a user. As the person of ordinary skill in the art will appreciate, one especially desirable form includes an alphanumeric display, e.g., formed as a liquid crystal display, an LED display, or a pixelated display. Of course, other forms are possible, e.g., a series of indicator lights that can illuminate and/or flash in a desired fashion to alert the user to status. The time and/or volume meter can also provide for user input, e.g., input of the predetermined time and/or predetermined volume to be used in the dispensing method, for example, through a keypad, a touchscreen, one or more sliders, and/or one or more knobs. In certain embodiments, an appropriately programmed mobile phone or tablet device can be used as part of the time and/or volume meter (e.g., outfitted with appropriate wired or wireless connection to the insulation dispenser and programmed with an application to provide for display and control as necessary).

After the user begins dispensing the expanding foam insulation material by actuating the actuator, dispensing can continue for a desired time and/or volume of material dispensed. While material is dispensed, the time and/or volume meter counts time and/or volume dispensed. During the dispensing, the time and/or volume meter can provide feedback to the user. For example, in certain embodiments, an indication of elapsed time after the start time or dispensed volume beyond the zero volume is displayed to the user during dispensing. In certain such embodiments, the indication of elapsed time or dispensed volume can be a visual indication. For example, the visual indication can include one or more of a time and/or volume count-up, a time and/or volume countdown, a status bar showing a fraction of completion with respect to the predetermined time and/or volume, a change in rate of flashing of an indicator light, and serial illumination of a series one or more indicator lights. In certain embodiments, the indication of elapsed time after the start time or dispensed volume beyond the zero volume includes a physical indication, for example, a series of vibrations or mild electric pulses. In certain embodiments, the indication of elapsed time after the start time or dispensed volume beyond the zero volume includes an audio indication, e.g., one or more of a beeping, a buzzing or a clicking. The indication of elapsed time and/or dispensed volume can be used by the user to anticipate when to stop dispensing. However, in cases where a separate stop indication is provided as described below, indication of elapsed time and/or dispensed volume (while useful) is not required.

In certain desirable embodiments, the time and/or volume meter provides the user a stop indication (e.g., one or more of a visual stop indication, a physical stop indication and/or an audio stop indication), and in response the user actuates the valve to stop dispensing. How the user actuates the valve to stop dispensing will depend on the configuration of the insulation dispenser. For example, in cases where the insulation dispenser is configured as a “gun,” the user can simply release the trigger to actuate the valve to stop dispensing.

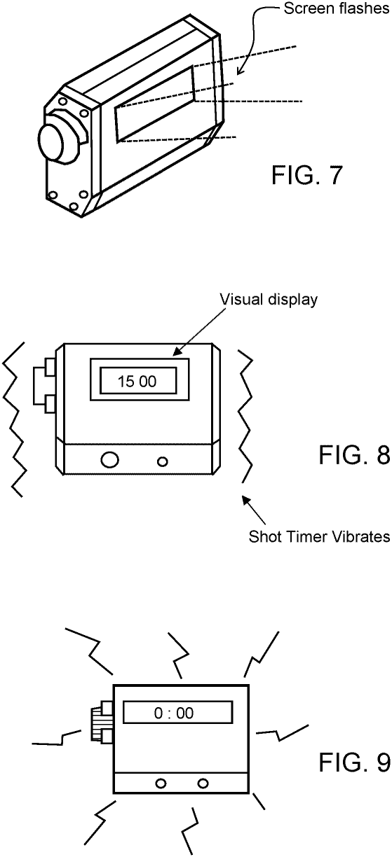

A wide variety of stop indications can be used, separately or in combination. In certain embodiments, the stop indication includes a visual stop indication, e.g., a flashing light (such as the flashing of a display or the flashing of the indicator light), the approach or reaching of a predetermined time and/or volume, or a display of a stop word, icon or signal on a display, or the illumination of a stop light. For example, in the embodiment shown in schematic view in FIG. 7, a screen can flash to provide the visual stop indication. In other embodiments, the user can watch the indication of elapsed time or dispensed volume (e.g., especially when it is counting down) to determine when the desired amount of material has been dispensed, and actuate the valve to stop dispensing in response thereto. For example, in the embodiment of FIG. 8, the visual display has counted up to 15:00; the user, knowing that the desired dispense time was 15 minutes, can actuate the valve in response to the visual display approaching or reaching that desired time. In certain embodiments, the stop indication includes an audible stop indication, e.g., a beeping, a buzzing or a clicking. The person of ordinary skill in the art can select a sound that will be heard and understood beyond the noise of a construction area. In certain embodiments, the stop indication includes a physical stop indication, such as a vibration (as indicated in FIG. 8) or a mild electric pulse (as shown in FIG. 9, which also shows a countdown timer counted down to 0:00).

The indications described herein, including the visual indications (i.e., including the visual stop indication), the physical indications (i.e., including the visual stop indication) and the audio indications (i.e., including the visual stop indication) can be provided by a variety of devices configured in a variety of ways suitable to provide the desired information to the user from the time and/or volume meter. For example, in certain embodiments, one or more of the visual indications (i.e., including the visual stop indication), the physical indications (i.e., including the visual stop indication) and the audio indications (i.e., including the visual stop indication) is provided by the insulation dispenser itself. This can be, e.g., by an electronic display on the insulation dispenser itself (for example, a LCD, an LED display, a pixelated display, and/or a series of lights), which can be part of the time and/or volume meter or in communication (wired or wireless) therewith. In certain embodiments, one or more of the indications is a vibration of or an electric pulse conducted by a part of the insulation dispenser in contact with the user (e.g., a handle being held by the user, or the trigger being held by the user). Such vibrations and/or pulses can be encoded to provide the desired information to the user (e.g., with short pulses indicating count-up or count-down of time/volume, and a long pulse as a stop indication). In certain embodiments, one or more of the indications is a sound emitted by the insulation dispenser (e.g., through a speaker or buzzer thereof).

But in other embodiments, one or more of the indications is provided by an indicator device remote from the insulation dispenser. Such remote indicator devices can be, e.g., provided as part of the time and/volume meter, or separate from and in wireless communication or wired communication with the time and/or volume meter. Similar types of indications as otherwise described herein can be used. For example, in certain embodiments, one or more of the indications is provided by an electronic display (for example, a LCD, an LED display, a pixelated display, and/or a series of lights). In certain embodiments, one or more of the indications is a vibration of or an electric pulse conducted by a part of the indicator device in contact with the user (e.g., a handle being held by the user, or the trigger being held by the user). Such vibrations and/or pulses can be encoded to provide the desired information to the user (e.g., with short pulses indicating count-up or count-down of time/volume, and a long pulse as a stop indication). In certain embodiments, one or more of the indications is a sound emitted by the indicator device (e.g., through a speaker or buzzer of the indicator device, such as an earpiece in the ear of the user).

In many embodiments it can be preferable for the user to perform the actuation of the valve to stop dispensing. This allows the user to provide ultimate control of the dispensing of the expanding foam insulation material and forces the user to remain mentally engaged with the process so as to avoid accidentally overfilling the cavity and to be on guard for any other issues. User control may also be desirable with respect to control valves of types that affect the frothing or mixing quality of the expanding foam insulation material. User control can also be desirable in situations where light weight and agility are important aspects of dispenser design, e.g., when for use at height or maneuvering around confined spaces.

However, in certain embodiments, the actuation of the valve to stop dispensing is performed by a valve controller (e.g., of the insulation dispenser) in response to a signal from the time and/or volume meter. In such embodiments, the time and/or volume meter can start counting time/volume when the user actuates the valve to start dispensing, but then the actuation of the valve to stop dispensing is performed by a valve controller upon a signal from the meter when a predetermined time after the start time elapses or a predetermined volume of the expanding foam insulation material beyond the zero volume is dispensed. The person of ordinary skill in the art will appreciate that there are a variety of controllable valves, e.g., based on solenoids, are suitable for controlling the flow of the expanding foam insulation material. And a variety of electronic or computer-based systems are suitable for use as valve controllers. In these embodiments, actuation by the user to start dispensing can include pulling a trigger or pressing a button to send an electronic signal to a valve controller, which opens the valve. The time and/or volume meter can send an electronic signal to the valve controller when a predetermined time after the start time elapses or a predetermined volume of the expanding foam insulation material beyond the zero volume is dispensed. The use of a valve controller to actuate the valve to stop dispensing can be used together with the indication features described above (especially the indicators of elapsed time and/or dispensed volume), or in certain embodiments can be used without such indicators.

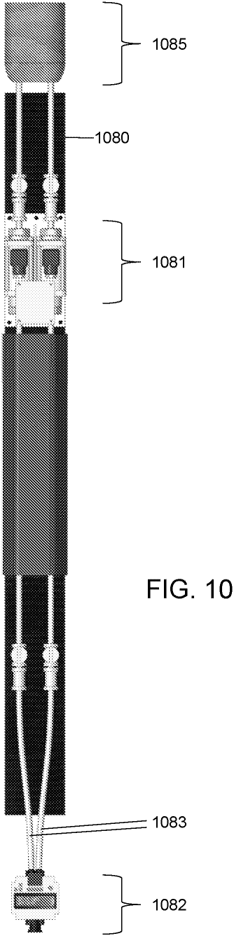

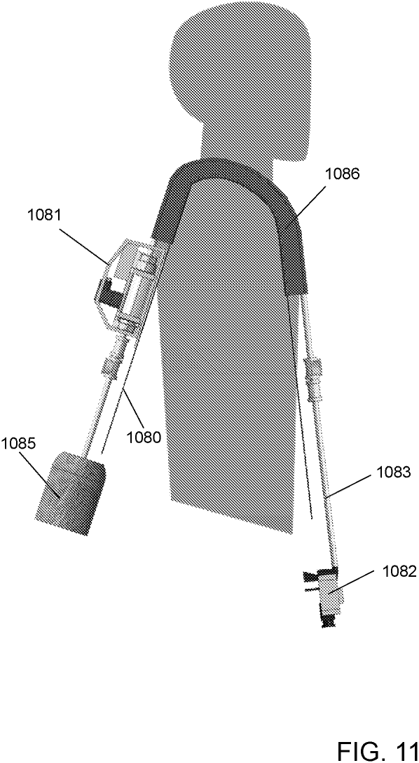

One embodiment of an insulation system including a valve controller is shown in the top and side schematic views of FIGS. 10 and 11. In this embodiment, the body includes a strap 1080, on which is disposed a valve assembly 1081 including one or more (here two) valves and a valve controller configured to open and close the valves in response to signals from the dispense head 1082. Tubes 1083 interconnect the valve assembly 1081 and the dispense head 1082. Dispense head 1082 includes a time and/or volume indicator and a mixing chamber for the precursors to be combined to form the expanding foam insulation material, as well as a trigger for the user to pull to begin dispensing. An electronic signal from the trigger can be conducted to the valve controller (e.g., along a cable, not shown) to cause the valve controller to open the valves to open, thereby allowing material to flow from the heated supply tubes 1085 through the tubes 1083 of the body, into the mixing chamber of the dispense head. The time and/or volume indicator of the dispense head can allow for user input, e.g., of a desired time or volume of dispense, which can then be used as the predetermined time for the processes described herein. The time and/or volume meter can be included, for example, as part of the valve assembly (e.g., in the same microprocessor as the valve controller), or as part of the time and/or volume indicator. The body can further include a shoulder rest 1086 to provide for weight distribution and ergonomic operation.

In certain embodiments of the processes described herein, it can be desirable for multiple “shots” of expanding foam insulation material to be dispensed into a single cavity. This is described, for example, in U.S. Pat. Application Publication no. 2017/0080614. Accordingly, in certain embodiments as otherwise described herein, multiple cycles of actuation to begin dispensing and actuation to stop dispensing are performed, so as to dispense multiple shots of the one or more precursors into the cavity. Such multiple cycles can be performed, for example, in any manner disclosed by U.S. Pat. Application Publication no. 2017/0080614. The multiple cycles can use the same predetermined volume and/or the same predetermined time, or different predetermined times and/or volumes.

As described above, the time and/or volume meter counts time and/or volume until a predetermined time elapses and/or volume is dispensed. While in some cases a time and/or volume meter can be preprogrammed with a desired predetermined time and/or volume, in certain embodiments the user will determine the predetermined time and/or volume (based, e.g., on the dimensions of the cavity to be filled, the presence or absence of any other materials in the cavity, and any other suitable considerations) and program the time and/or volume meter therewith. Accordingly, in certain embodiments, a method as otherwise described herein includes, before actuating the valve of the insulation dispenser to begin dispensing the one or more precursors of the expanding foam insulation material, encoding (e.g., by the user) the time and/or volume meter with the predetermined time and/or predetermined volume. In other embodiments, the time and/or volume meter can determine the predetermined time and/or volume based at least in part on some other user input (e.g., one or more of size of cavity, volume of cavity, type of expanding foam insulation material being dispensed), optionally together with information provided by the system itself (e.g., measured temperature, measured flow rate).

In various embodiments as described above, the elapsed time and/or dispensed volume as calculated by the time and/or volume meter is used to determine when to stop dispensing (e.g., by the user or by the valve controller). While it can be desirable to stop dispensing precisely when the predetermined time/volume is achieved, the person of ordinary skill in the art will appreciate that, especially when a human user is actuating the valve to stop dispensing, there may be some time/volume difference between the predetermined time/volume and the actual time elapsed/volume dispensed when dispensing is stopped.

In certain embodiments as otherwise described herein, the actuation to begin dispensing fixes a start time of a time meter; and the actuation to stop dispensing is performed when a predetermined time after the start time elapses (e.g., within 20 seconds before or after elapsing, e.g., with 10 seconds or within 5 seconds). Similarly, in certain embodiments as otherwise described herein, wherein the actuation to begin dispensing fixes a start time of a time meter; the actuation to stop dispensing is performed in response to a stop indication (e.g., within 20 seconds after the stop indication, e.g., with 10 seconds or within 5 seconds). In certain such embodiments, the method can include determining a dispense rate of the insulation dispenser relating expanded foam volume to dispense time. Such a calibration can be used to determine by the person of ordinary skill in the art to determine an appropriate predetermined dispense time for a desired cavity.

In certain embodiments as otherwise described herein, the wherein the actuation to begin dispensing fixes a zero volume of a volume meter; and the actuation to stop dispensing is performed when a predetermined volume has been dispensed (e.g., within 10%, within 5%, or within 2% of the predetermined volume). Similarly, in certain embodiments, the actuation to stop dispensing is performed in response to a stop indication (e.g., within 20 seconds after the stop indication, e.g., with 10 seconds or within 5 seconds). In certain such embodiments, one or more flow sensors measure the flow of the one or more precursors through the insulation dispenser, the flow sensors providing flow information to the volume meter. The flow sensors can be, for example, part of the insulation dispenser, or present in some other part of the system (e.g., at a separate valve assembly). These methods can include determining a dispense rate of the insulation dispenser relating expanded foam volume to dispense volume of one or more foam precursors or dispense volume of an expanding foam insulation material. Such a calibration can be used to determine by the person of ordinary skill in the art to determine an appropriate predetermined dispense volume for a desired cavity.

The present inventors have noted that it can be useful for the methods, devices and systems described herein to display to the user usage data with respect to the expanding foam insulation material (or the corresponding expanded foam insulation material) or one or more precursors thereof. As described below, such usage data can be used in a variety of manners.

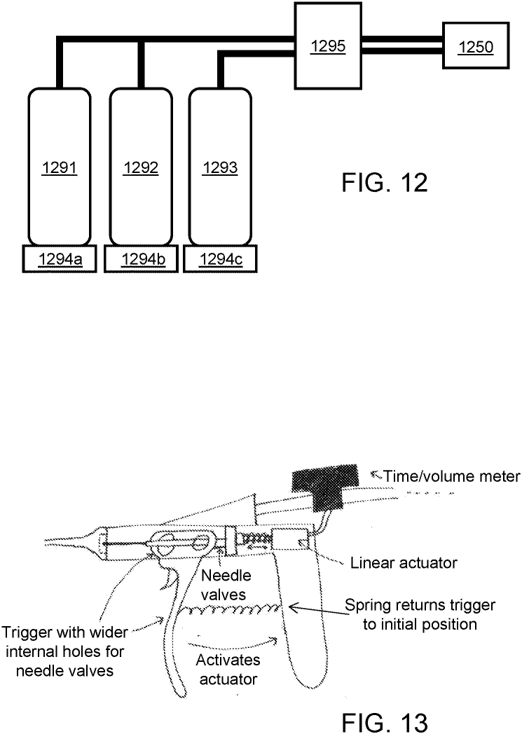

One issue typically encountered in insulation dispensing systems is the need to change containers of insulation precursors (e.g., the “A” and “B” components mentioned above) as they become empty. A schematic view of an insulation system is shown in FIG. 12. In this system, containers 1291, 1292 and 1293 include insulation precursors; as drawn, containers 1291 and 1292 contain a blowing agent and an “A” component of an expanding foam insulation material, and container 1293 contains a “B” component of the expanding foam insulation material. These containers are in fluid communication with a proportioning valve 1295, which ensures that the flows of the materials supplied by the containers are in the correct proportion. A proportioning valve is in fluid communication with an insulation dispenser or insulation dispensing system 1250 (e.g., as described herein). In such a system, the usage data can provide the amount of material left in one or more of the containers. Such data can be calculated in a number of ways. For example, the mass of the containers can be monitored by one or more scales (1294a-c); knowledge of the empty container weight allows the calculation of the net amount of material remaining in the container (e.g., as a weight or as a percentage filled). Similarly, the amount of material dispensed can be estimated based on total elapsed time of dispensing or total volume dispensed since container replacement. Or a flow meter within the system can measure total amount dispensed. The usage data can be provided to the indicator device and displayed, e.g., as a set of numbers, one or more icons, or one or more lights. Provision of usage data with respect to fill levels of such containers can be helpful so that the user knows when to interrupt dispensing operations to go change out an emptying container. Such usage data can include the provision of a source change notification when a container from which one or more of the one or more precursors is supplied is nearly empty (e.g., at a preselected fill level that is no more than 20%, no more than 10%, or even no more than 5%). This can be especially helpful, as containers are usually in a trailer or other heated enclosure somewhat remote from the site of dispensing.

More generally, knowledge of the total amount of material dispensed can be useful for other purposes, for example, using system throughput for quality control, determining installer performance, understanding process efficiency and consistency, and determining whether any system components are faulty or fouled.

Another embodiment of an insulation dispenser according to the disclosure is shown in schematic cross-sectional view in FIG. 13. Here, the insulation dispenser is in the form of a “gun,” having a trigger as the user-actuatable actuator. This trigger itself does not directly control the needle valves, but rather actuates a secondary actuator that actuates the needle valves to open and close them. In certain embodiments, the trigger signals the time and/or volume meter that the trigger has been pulled, and the time and/or volume meter operates the actuator to open the needle valves, then to close the needle valves to stop dispensing when the predetermined time and/or volume is achieved. The trigger can be returned to position by a spring. Such a dispensing gun can be similar to a conventional dispensing gun, e.g., with wider internal holes for allowing the needle valves to pass through.

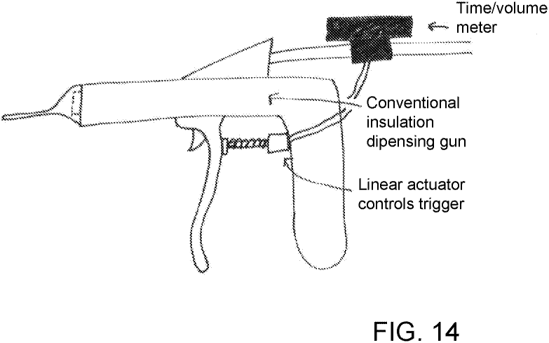

Another embodiment of an insulation dispenser according to the disclosure is shown in schematic cross-sectional view in FIG. 14. Here, a conventional insulation dispensing gun can be modified only on its outside to provide the desired functionality. The insulation dispenser further comprises an actuator mounted on the exterior of the body, the actuator being configured to pull the trigger to begin dispensing. to hold the trigger during dispensing, and to return the trigger to an unpulled state to end the dispensing. The actuator is actuatable by the user, e.g., through any of the user inputs discussed herein (as part of the input to the time/volume meter or otherwise). For example, the time and/or volume meter can be configured to cause the actuator to pull the trigger in response to a command by the user. The time and/or volume meter can be configured to cause the actuator to return the trigger to an unpulled state when the predetermined time and/or volume is achieved. Accordingly, the user can control the dispensing through the intermediary of a keypad, an app, a push-button, or some other electronic input, while the overall insulation dispenser can remain based on a conventional trigger-based insulation dispensing gun.

Another aspect of the disclosure is a kit for the use of an expanding insulating foam material as described herein. The kit includes a plurality of containers (e.g., two), each container including one or more components of the expanding foam insulation but neither container containing all the components of the expanding foam insulation. The components are selected such that no single container provides the totality of the reactants necessary for the foam to cure; rather, streams from the containers must be mixed to provide a curable material. For example, in certain embodiments, a first container contains polyol and/or polyamine components of the expanding insulating foam but does not contain any isocyanate components of the expanding insulating foam, and a second container contains isocyanate components of the expanding insulating foam but does not contain any polyol and/or polyamine components of the expanding insulating foam.

### EXAMPLES

As described above, the present inventors have determined certain kinetic parameters of expanding foam insulation materials to be important in reducing the risk of wall blow-out.

In a study of commercial materials, the present inventors determined that some foams had a relatively low risk of blow-out, but had poor fire rating. The material tested that had a Class A fire rating had a higher propensity to blow out walls.

| | | |
|---|---|---|
| Foam | Risk of wall blow-out walls | Class A fire rating at 4″ of thickness? |
| Commercial Material 1 | LOW | NO |
| Commercial Material 2 | LOW | NO |
| Commercial Material 3 | LOW | NO |
| Commercial Material 4 | HIGH | NO |

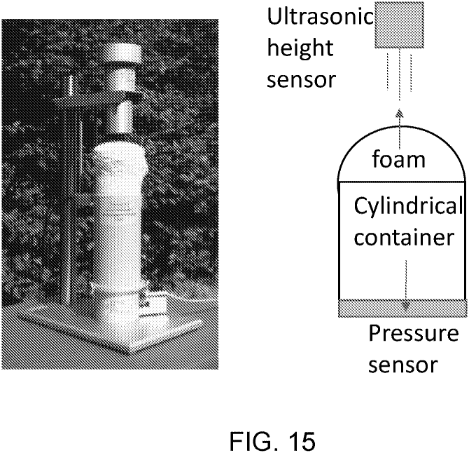

A set of experiments were performed using the FOAMAT® Foam Qualification System. A photograph and a schematic of the system are provided as FIG. 15. Each foam material was provided in the form two pressurized tanks A and B, which were opened and adjusted to approximately a 1:1 weight ratio. The dispensing pressure was about 50-150 psi. Approximately 100 grams (three second spray time) is sprayed into the 6″ diameter cardboard cylinder. At about 5-10 seconds from start time, the cylinder is placed under the ultrasonic sensor to start the recording data.

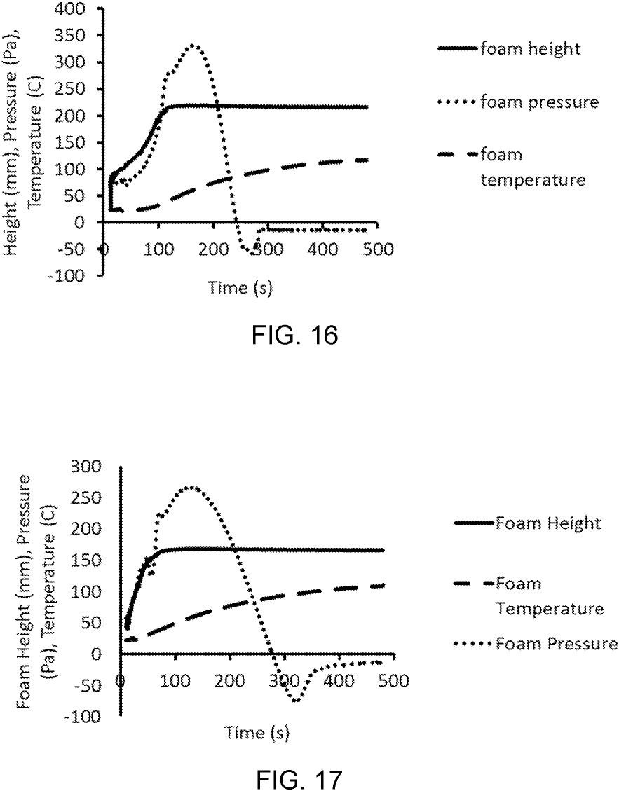

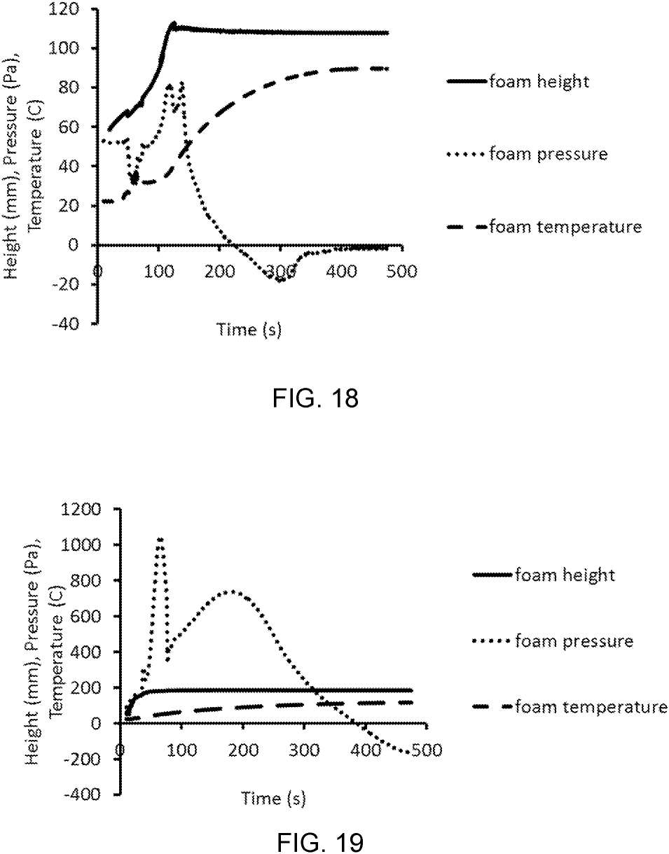

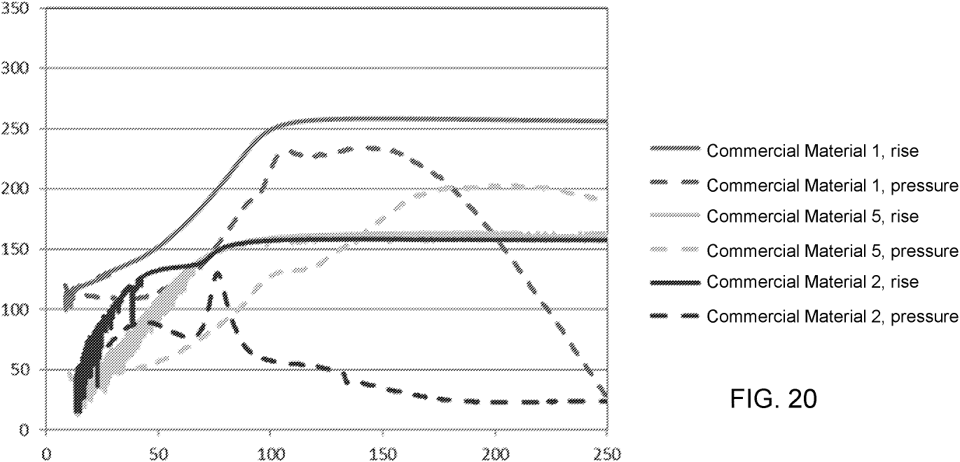

Data are shown in FIGS. 16-19 respectively for Commercial Material 1, Commercial Material 2, Commercial Material 3, and Commercial Material 4. FIG. 20 presents a graph comparing Commercial Material 1 and Commercial Material 2 with Commercial Material 5, which exhibited poor blow-out performance. Notably, the poor-performing material had a long lag time between the local pressure maximum and the time of 95% maximum height.

In a set of experiments, polyurethane polymerizable compositions were prepared. For each, using an overhead mixer, polyol(s), surfactant, water, catalyst and blowing agent were mixed in an appropriately-sized cup. Isocyanate was weighed into a separate container, into which the polyol-containing mixture was poured, followed by mixing for 15 seconds at 1500 rpm with a mechanical mixer. The mixture was poured into the FOAMAT® Foam Qualification System, using an FPM Pressure Plate and cardboard tube foam container, recording the rise height and rise pressure as a function of time. After 10 minutes, the foam and container was removed from the system. The sample was allowed to cure at room temperature overnight. The density of the resultant foam was measured, and the rise pressure was normalized with respect to density. The present inventors note that rise height would be an alternative way to normalize the data for analysis.

Six experimental polyurethane foams were produced, as shown in the table below. All amounts of material are provided as parts by weight of the commercially-available component.

| Component | Type | P1 | P2 | P3 | P4 | P5 | P6 |
|---|---|---|---|---|---|---|---|
| Jeffol FX 31 167 | polyether polyol | 25 | 25 | 25 | 20 | 20 | 20 |
| Jeffol G 30 650 | polyether polyol | 45 | 45 | 45 | 50 | 50 | 50 |
| PPG 1000 | polyether polyol | 30 | 30 | 30 | 30 | 30 | 30 |
| Silstab 2580 | silicone surfactant | 1.5 | 1.5 | 1.5 | 1.5 | 1.5 | 1.5 |
| Z-100 | blow-favoring catalyst | 2 | 2 | 2 | 2 | 2 | 2 |
| Water | | 1.25 | 1.25 | 1.25 | 1.25 | 1.25 | 1.25 |
| Solstice LBA | HFO liquid blowing agent | 13 | 12.5 | 13 | 13 | 13 | 13 |
| Rubinate M | standard polymeric MDI | 20 | 67 | 84 | 120 | 136 | 171 |
| Rubinate 1680 | modified pure MDI | 117 | 67 | 84 | - | - | - |
| iso index | | 120 | 120 | 150 | 105 | 120 | 150 |
| Average isocyanate functionality | | 2.1 | 2.4 | 2.4 | 2.7 | 2.7 | 2.7 |
| Average polyol functionality | | 2.7 | 2.7 | 2.7 | 2.7 | 2.7 | 2.7 |

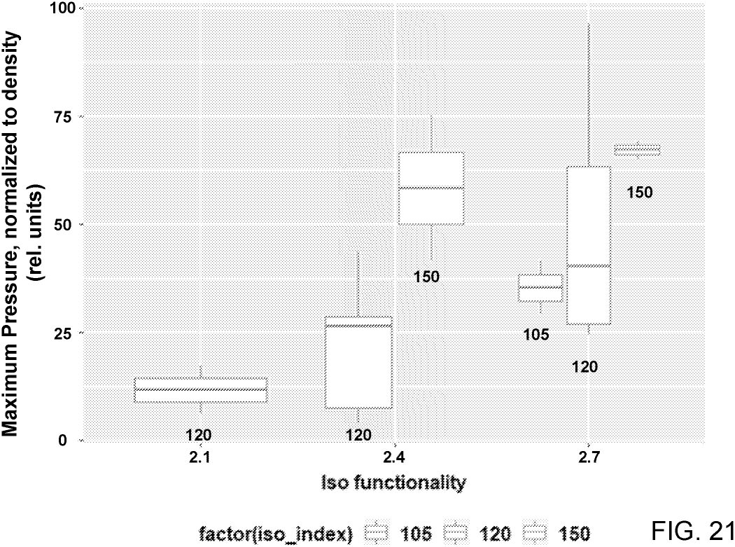

Results are shown in FIG. 21. The results demonstrate two effects. First, at an equivalent iso index, decreasing the isocyanate functionality decreases the relative maximum pressure. Second, at an equivalent isocyanate functionality, decreasing the iso index decreases the normalized pressure. Accordingly, use of iso indexes of no more than 140 and/or iso functionalities of no more than 2.5 (or other values as recited herein) can advantageously provide for lower pressures and thus reduced risk of wall blowout when used in foam insulations.

The present inventors also submit that the results above demonstrate that a reduced polyol/polyamine functionality will also provide for desirably reduced pressure at gelation. The gelation mechanism depends on the number and density of reaction between —OH/—NH₂ and —NCO. Degree of conversion is known to be an inverse function of the square root of [(f_{polyol}-1)(f_{polyisocyanate}-1)], and so decreasing the functionality of either component should have the same effect. As such, the effect of reducing the relative number of —OH/—NH₂ groups will result in similar reduction of pressure at gelation.

Various aspects and embodiments of the disclosure are provided by the following enumerated embodiments, which can be combined in an number and in any fashion not logically or technically inconsistent.

Embodiment 1. An expanding foam insulation material, the expanding foam insulation material being dispensable and expandable to provide an expanded foam insulation material, wherein
(a) the expanding foam insulation material is a polymerizable composition comprising at least one polyol and at least one polyisocyanate, and the expanded foam insulation material is a polyurethane;
(b) the expanding foam insulation material is a polymerizable composition comprising at least one polyamine and at least one polyisocyanate, and the expanded foam insulation material is a polyurea; or
(c) the expanding foam insulation material is a polymerizable composition comprising at least one polyol, at least one polyamine and at least one polyisocyanate, and the expanded foam insulation material is a mixed polyurethane/polyurea; and
   (i) the polyisocyanate component has a polyisocyanate functionality of no more than 2.6, e.g., in the range of 1.9-2.6, or 2.0-2.6, or 2.1-2.6;
   (ii) the polyol and/or polyamine component has a polyol and/or polyamine functionality of no more than 3.5, e.g., in the range of 1.9-3.5, or 2.0-3.5, or 2.1-3.5; and/or
   (iii) the iso index of the polymerizable composition is no more than 200, e.g., in the range of 80-200, or 90-200, or 100-200.

Embodiment 2. An expanding foam insulation material according to Embodiment 1, the expanding foam insulation material having a maximum foam height; and no local pressure maximum of more than 500 Pa, wherein for each local pressure maximum in excess of 50 Pa, a time difference between a time of the local pressure maximum and a time of 95% maximum foam height is no more than 80 seconds.

Embodiment 3. An expanding foam insulation material according to Embodiment 1 or Embodiment 2, the expanding foam insulation material having a maximum foam height; for a local pressure maximum after a time of maximum foam height, a time difference between a time of the local pressure maximum and a time of 95% maximum foam height is no more than 80 seconds.

Embodiment 4. An expanding foam insulation material, the expanding foam insulation material being dispensable and expandable to provide an expanded foam insulation material, the expanding foam insulation material having a maximum foam height; and no local pressure maximum of more than 500 Pa, wherein for each local pressure maximum in excess of 50 Pa, a time difference between a time of the local pressure maximum and a time of 95% maximum foam height is no more than 80 seconds.

Embodiment 5. An expanding foam insulation material, the expanding foam insulation material being dispensable and expandable to provide an expanded foam insulation material, the expanding foam insulation material having a maximum foam height; for a pressure maximum after a time of maximum foam height, a time difference between a time of the pressure maximum and a time of 95% maximum foam height is no more than 80 seconds.

Embodiment 6. The expanding foam insulation material according to any of Embodiments 2 and 4, wherein the expanding foam insulation material has no local pressure maximum of more than 300 Pa, e.g., no local pressure maximum of more than 250 Pa.

Embodiment 7. The expanding foam insulation material according to any of Embodiments 2 and 4, wherein the expanding foam insulation material has a highest local pressure maximum in the range of 50-300 Pa, e.g., 100-300 Pa, or 50-250 Pa, or 100-250 Pa.

Embodiment 8. The expanding foam insulation material according to any of Embodiments 2, 4, 6 and 7, wherein for each local pressure maximum in excess of 50 Pa, a time difference between a time of the local pressure maximum and a time of 95% maximum foam height is no more than 75 seconds, e.g., no more than 70 seconds.

Embodiment 9. The expanding foam insulation material according to any of Embodiments 2, 4, 6 and 7, wherein for each local pressure maximum in excess of 50 Pa, a time difference between a time of the local pressure maximum and a time of 95% maximum foam height is no more than 65 seconds, e.g., no more than 60 seconds.

Embodiment 10. The expanding foam insulation material according to any of Embodiments 2, 4, 6 and 7, wherein for each local pressure maximum in excess of 50 Pa, a time difference between a time of the local pressure maximum and a time of 95% maximum foam height is no more than 50 seconds, e.g., no more than 40 seconds.

Embodiment 11. The expanding foam insulation material according to any of Embodiments 2, 4, 6 and 7, wherein for each local pressure maximum in excess of 50 Pa, a time difference between a time of the local pressure maximum and a time of 95% maximum foam height is no more than 30 seconds, e.g., no more than 20 seconds.

Embodiment 12. The expanding foam insulation material according to any of Embodiments 3 and 5, wherein a time difference between a time of the pressure maximum and a time of 95% maximum foam height is no more than 75 seconds, e.g., no more than 70 seconds.

Embodiment 13. The expanding foam insulation material according to any of Embodiments 3 and 5, wherein a time difference between a time of the pressure maximum and a time of 95% maximum foam height is no more than 65 seconds, e.g., no more than 60 seconds.

Embodiment 14. The expanding foam insulation material according to any of Embodiments 3 and 5, wherein a time difference between a time of the pressure maximum and a time of 95% maximum foam height is no more than 50 seconds, e.g., no more than 40 seconds.

Embodiment 15. The expanding foam insulation material according to any of Embodiments 3 and 5, wherein a time difference between a time of the pressure maximum and a time of 95% maximum foam height is no more than 30 seconds, e.g., no more than 20 seconds.

Embodiment 16. The expanding foam insulation material according to any of Embodiments 3 and 5, wherein a time difference between a time of the pressure maximum and a time of 95% maximum foam height is no more than 10 seconds, e.g., no more than 5 seconds.

Embodiment 17. The expanding foam insulation material according to any of Embodiments 1-16, having a time of 95% maximum foam height of no more than 4 minutes, e.g., no more than 3 minutes.

Embodiment 18. The expanding foam insulation material according to any of Embodiments 1-17, having a time of 95% maximum foam height of at least 20 seconds, e.g., at least 40 seconds.

Embodiment 19. The expanding foam insulation material according to any of Embodiments 1-18, having a shrinkage after five minutes of no more than 5%.

Embodiment 20. The expanding foam insulation material according to any of Embodiments 1-19, wherein a maximum temperature in the geometric center of the foam during expansion is no more than 120° C.

Embodiment 21. The expanding foam insulation material according to any of Embodiments 1-19, wherein a maximum temperature in the geometric center of the foam during expansion is no more than 100° C., e.g., no more than 80° C.

Embodiment 22. The expanding foam insulation material according to any of Embodiments 1-21, for a volume of expanded foam insulation material over the range of 1000 cm³ to 100000 cm³, the volume of expanded foam insulation material does not deviate from a linear relationship with the mass of expanding foam insulation material by more than 15%, e.g., does not deviate by more than 10%.

Embodiment 23. The expanding foam insulation material according to any of Embodiments 1-22, wherein the expanded foam insulation material is a polyurethane foam, a polyurea foam, or a mixed polyurethane/polyurea foam.

Embodiment 24. The expanding foam insulation material according to any of Embodiments 1-22, wherein the expanding foam insulation material is a polymerizable composition comprising at least one polyol and at least one polyisocyanate, and the expanded foam insulation material is a polyurethane.

Embodiment 25. The expanding foam insulation material according to any of Embodiments 1-22, wherein the expanding foam insulation material is a polymerizable composition comprising at least one polyamine and at least one polyisocyanate, and the expanded foam insulation material is a polyurea.

Embodiment 26. The expanding foam insulation material according to any of Embodiments 1-22, wherein the expanding foam insulation material is a polymerizable composition comprising at least one polyol, at least one polyamine and at least one polyisocyanate, and the expanded foam insulation material is a mixed polyurethane/polyurea.

Embodiment 27. The expanding foam insulation material according to Embodiment 24 or Embodiment 26, wherein the at least one polyol includes at least one polyether polyol (e.g., a polyethylene oxide / polypropylene oxide polyol) and/or at least one polyester polyol.

Embodiment 28. The expanding foam insulation material according to any of Embodiments 24, 26 and 27, wherein the at least one polyol includes a polycarbonate polyol.

Embodiment 29. The expanding foam insulation material according to any of Embodiments 24-28, wherein the at least one polyisocyanate includes toluene diisocyanate or methylene diphenyl diisocyanate (e.g., in an oligomeric or polymeric form).

Embodiment 30. The expanding foam insulation material according to any of Embodiments 24-29, wherein the polymerizable composition has an iso index in the range of 80-450.

Embodiment 31. The expanding foam insulation material according to any of Embodiments 24-29, wherein the polymerizable composition has an iso index in the range of 110-450, e.g., 110-350 or 110-250.

Embodiment 32. The expanding foam insulation material according to any of Embodiments 24-31, wherein the polyisocyanate component has a polyisocyanate functionality of no more than 2.6, e.g., in the range of 1.9-2.6, or 2.0-2.6, or 2.1-2.6.

Embodiment 33. The expanding foam insulation material according to any of Embodiments 24-31, wherein the polyisocyanate component has a polyisocyanate functionality of no more than 2.5, e.g., in the range of 1.9-2.5, or 2.0-2.5, or 2.1-2.5.

Embodiment 34. The expanding foam insulation material according to any of Embodiments 24-31, wherein the polyisocyanate component has a polyisocyanate functionality of no more than 2.4, e.g., in the range of 1.9-2.4, or 2.0-2.4, or 2.1-2.4.

Embodiment 35. The expanding foam insulation material according to any of Embodiments 24-31, wherein the polyisocyanate component has a polyisocyanate functionality of no more than 2.3, e.g., in the range of 1.9-2.3, or 2.0-2.3, or 2.1-2.3.

Embodiment 36. The expanding foam insulation material according to any of Embodiments 24-31, wherein the polyisocyanate component has a polyisocyanate functionality of no more than 2.2, e.g., in the range of 1.9-2.2, or 2.0-2.2.

Embodiment 37. The expanding foam insulation material according to any of Embodiments 31-36, wherein the polyol and/or polyamine functionality of the polyol/polyamine component is in the range of 1.9-5.0, e.g., 1.9-4.0, or 1.9-3.8, or 1.9-3.5, or 1.9-3.0, or 1.9-2.7, or 1.9-2.8, or 1.9-2.7, or 1.9-2.6.

Embodiment 38. The expanding foam insulation material according to any of Embodiments 24-36, wherein the polyol and/or polyamine component has a polyol and/or polyamine functionality of no more than 3.5, e.g., in the range of 1.9-3.5, or 2.0-3.5, or 2.1-3.5.

Embodiment 39. The expanding foam insulation material according to any of Embodiments 24-36, wherein the polyol and/or polyamine component has a polyol and/or polyamine functionality of no more than 3.2, e.g., in the range of 1.9-3.2, or 2.0-3.2, or 2.1-3.2.

Embodiment 40. The expanding foam insulation material according to any of Embodiments 24-36, wherein the polyol and/or polyamine component has a polyol and/or polyamine functionality of no more than 3.0, e.g., in the range of 1.9-3.0, or 2.0-3.0, or 2.1-3.0.

Embodiment 41. The expanding foam insulation material according to any of Embodiments 24-36, wherein the polyol and/or polyamine component has a polyol and/or polyamine functionality of no more than 2.8, e.g., in the range of 1.9-2.8, or 2.0-2.8, or 2.1-2.8.

Embodiment 42. The expanding foam insulation material according to any of Embodiments 24-36, wherein the polyol and/or polyamine component has a polyol and/or polyamine functionality of no more than 2.5, e.g., in the range of 1.9-2.5, or 2.0-2.5, or 2.1-2.5.

Embodiment 43. The expanding foam insulation material according to any of Embodiments 24-36, wherein the polyol and/or polyamine component has a polyol and/or polyamine functionality of no more than 2.4, e.g., in the range of 1.9-2.4, or 2.0-2.4, or 2.1-2.4.

Embodiment 44. The expanding foam insulation material according to any of Embodiments 24-36, wherein the polyol and/or polyamine component has a polyol and/or polyamine functionality of no more than 2.3, e.g., in the range of 1.9-2.3, or 2.0-2.3, or 2.1-2.3.

Embodiment 45. The expanding foam insulation material according to any of Embodiments 24-36, wherein the polyol and/or polyamine component has a polyol and/or polyamine functionality of no more than 2.2, e.g., in the range of 1.9-2.2, or 2.0-2.2.

Embodiment 46. The expanding foam insulation material according to any of Embodiments 37-45 (as they depend from any Embodiment but for 32-36), wherein the polyisocyanate functionality of the polyisocyanate component is in the range of 1.9-3.0, e.g. 1.9-2.9, or 1.9-2.8, or 1.9-2.7, or 1.9-2.6.

Embodiment 47. The expanding foam insulation material according to any of Embodiments 24-29 and 32-46, wherein the iso index of the polymerizable composition is no more than 200, e.g., in the range of 80-200, or 90-200, or 100-200.

Embodiment 48. The expanding foam insulation material according to any of Embodiments 24-29 and 32-46, wherein the iso index of the polymerizable composition is no more than 180, e.g., in the range of 80-180, or 90-180, or 100-180.

Embodiment 49. The expanding foam insulation material according to any of Embodiments 24-29 and 32-46, wherein the iso index of the polymerizable composition is no more than 160, e.g., in the range of 80-160, or 90-160, or 100-160.

Embodiment 50. The expanding foam insulation material according to any of Embodiments 24-29 and 32-46, wherein the iso index of the polymerizable composition is no more than 140, e.g., in the range of 80-140, or 90-140, or 100-140.

Embodiment 51. The expanding foam insulation material according to any of Embodiments 24-29 and 32-46, wherein the iso index of the polymerizable composition is no more than 130, e.g., in the range of 80-130, or 90-130, or 100-130.

Embodiment 52. The expanding foam insulation material according to any of Embodiments 24-29 and 32-46, wherein the iso index of the polymerizable composition is no more than 120, e.g., in the range of 80-120, or 90-120, or 100-120.

Embodiment 53. The expanding foam insulation material according to any of Embodiments 24-29 and 32-46, wherein the iso index of the polymerizable composition is no more than 110, e.g., in the range of 80-110, or 90-110.

Embodiment 54. The expanding foam insulation material according to any of Embodiments 24-53, wherein the polymerizable composition further comprises a blowing agent (e.g., a hydrofluorocarbon (e.g., hydrofluoroolefin) blowing agent).

Embodiment 55. The expanding foam insulation material according to any of Embodiments 1-54, wherein the expanded foam insulation material has a flame spread less than 25 at a thickness of 4″ as measured by ASTM E84.

Embodiment 56. The expanding foam insulation material according to any of Embodiments 1-55, wherein the expanded foam insulation material has a smoke index less than 450 at a thickness of 4″ as measured by ASTM E84.

Embodiment 57. The expanding foam insulation material according to Embodiment 55 or Embodiment 56, wherein the expanding foam insulation further includes one or more particulate fire retardants selected from melamine polyphosphate, ammonium polyphosphate, and expandable graphite, e.g., present in an amount up to 30 wt%, e.g., 1-30 wt%, or 5-20 wt%, or 1-10 wt%, or 5-15 wt%.

Embodiment 58. The expanding foam insulation material according to Embodiment 57, wherein the expanding foam insulation further includes a hydrophobic silica having an D50 particle size in the range of 10-1000 nm.

Embodiment 59. The expanding foam insulation material according to any of Embodiments 55-58, further comprising one or more minerals having a dehydratable water content of at least 20 wt%.

Embodiment 60. The expanding foam insulation material according to any of Embodiments 55-59, further comprising one or more water-containing minerals having a dehydratable water content, the one or more minerals being selected from aluminum trihydrate (e.g., gibbsite), magnesium dihydrate, gypsum and magnesium carbonate hydrate.

Embodiment 61. The expanding foam insulation material according to Embodiment 59 or Embodiment 60, wherein the one or more minerals are coated with a coating to enhance compatibility with the polymeric material of the foam (e.g., a hydrophobic coating).

Embodiment 62. The expanding foam insulation material according to any of Embodiments 59-61, wherein the one or more water-containing minerals are present in the expanding foam insulation in an amount in the range of 5-60 wt%, e.g., 5-45 wt% or 15-60 wt% or 15-45 wt% or 30-60 wt%.

Embodiment 63. The expanding foam insulation material according to any of Embodiments 55-62, wherein one or more halogenated flame retardants are present in the expanding foam insulation material, e.g., brominated alcohols such as polybrominated diphenyl ethers, tetrabromophthalates and their reaction products, tribromoneopentyl alcohol, dibromoneopentyl glycol, tribromophenol, and reaction products thereof; chlorinated organophosphates such as tris(1,3-dichloroisopropyl) phosphate, (1-chloro-2-propyl) phosphate, 2,2-bis(chloromethyl)propane-1,3-diyl tetrakis(1-chloropropan-2-yl) bis(phosphate), and tris (2-chloroethyl) phosphate; and chlorinated paraffins.

Embodiment 64. The expanding foam insulation material according to Embodiment 63, wherein the one or more halogenated flame retardants are present in an amount up to 20 wt%, e.g., 5-20 wt%, or 10-20 wt%

Embodiment 65. The expanding foam insulation material according to Embodiment 63 or Embodiment 64, wherein the expanding foam insulation material further includes antimony trioxide.

Embodiment 66. The expanding foam insulation material according to Embodiment 65, wherein the antimony trioxide is present in an amount of 50% - 400% of the weight of the halogenated flame retardant(s), e.g., 100%-300%.

Embodiment 67. The expanding foam insulation material according to any of Embodiments 55-66, wherein the expanding foam insulation material includes a non-halogenated phosphate flame retardant, e.g., triethyl phosphate (TEP), resorcinol bis(diphenyl phosphate), and phosphate plasticizers.

Embodiment 68. The expanding foam insulation material according to Embodiment 67, wherein the non-halogenated phosphate flame retardant is present in the expanding foam insulation material in an amount in the range of 0.5 wt% to 20 wt%, e.g., 1-20 wt%, 5-20 wt%, 1-10 wt% or 5-15 wt%.

Embodiment 69. The expanding foam insulation material according to any of Embodiments 55-68, wherein the expanding foam insulation material includes a reactive phosphorus-based flame retardant, for example, polyphosphonate-co-carbonates (e.g., Nofia products from FRX), phosphorus polyols (e.g., OP550 or OP560 from Clariant), alkylphosphate oligomers (e.g., Fyrol PNX from ICL), diethyl (hydroxymethyl) phosphonate, and 9-10-dihydro-9-oxa-10-phosphaphenanthrene-10-oxide (DOPO) and its derivatives, e.g., present in the composition in an amount up to 20 wt%, e.g., 1-20 wt%, or 5-20 wt%, or 10-20 wt%, or 1-10 wt%, or 5-10 wt%, or 1-5 wt%.

Embodiment 70. An expanded foam insulation material that is the cured product of an expanding foam insulation product of any of Embodiments 1-69.

Embodiment 71. A method for providing a cavity of a building with an expanded foam insulation, the cavity being enclosed by one or more walls including a first wall, the method comprising

performing one or more dispensing shots (e.g., discrete dispensing shots), each comprising dispensing an amount of the expanding foam insulation of any of Embodiments 1-69 into the cavity; and then allowing the dispensed amount of expanding foam insulation to substantially finish expanding after it is dispensed in the cavity, thereby forming a shot of expanded foam insulation material in the cavity.

Embodiment 72. The method according to Embodiment 71, wherein the cavity has a first wall having an aperture formed therein, and wherein the expanding foam insulation is dispensed into the cavity from the insulation dispenser through the aperture.

Embodiment 73. The method according to Embodiment 72, further comprising forming the aperture in the first wall before performing the one or more discrete dispensing shots.

Embodiment 74. The method according to Embodiment 72 or Embodiment 73, further comprising, after dispensing the foam insulation, patching the aperture.

Embodiment 75. The method according to any of Embodiments 71-74, wherein multiple discrete dispensing shots are performed, so as to form multiple shots of expanded foam in the cavity, the multiple shots of expanded foam being formed as multiple layers.

Embodiment 76. The method according to Embodiment 66, wherein the last dispensing shot of the multiple discrete dispensing shots is substantially smaller than (e.g., no more than 75 wt% of) the penultimate dispensing shot of the multiple discrete dispensing shots.

Embodiment 77. The method according to Embodiment 76, wherein, but for the last dispensing shot, the multiple discrete dispensing shots are performed to dispense substantially the same amount of expanding foam insulation (e.g., within 20% of the average, or within 10% of the average).

Embodiment 78. A method according to any of Embodiments 71-77, wherein each dispensing shot comprises
actuating a valve (e.g., of an insulation dispenser) to begin dispensing expanding foam insulation (e.g., from the insulation dispenser) into the cavity, the actuation being performed by a user, the actuation by the user fixing a start time and/or a zero volume of a time and/or volume meter; then,
dispensing the expanding foam insulation (e.g., from the insulation dispenser) into the cavity as the time and/or volume meter counts time and/or volume dispensed; then
when a predetermined time after the start time elapses or a predetermined volume of the expanding foam insulation beyond the zero volume is dispensed as measured by the time and/or volume meter, actuating the valve to stop dispensing the expanding foam insulation into the cavity.

Embodiment 79. The method according Embodiment 78, wherein the user pulls a trigger of the insulation dispenser (e.g., a dispensing gun) to actuate the valve to begin dispensing.

Embodiment 80. The method according to Embodiment 78 or Embodiment 79, wherein an indication of elapsed time after the start time or dispensed volume beyond the zero volume is provided to the user during dispensing.

Embodiment 81. The method according to Embodiment 80, wherein the indication of elapsed time after the start time or dispensed volume includes a visual indication.

Embodiment 82. The method according to Embodiment 81, wherein the visual indication includes one or more of a time and/or volume count-up, a time and/or volume countdown, a status bar showing a fraction of completion with respect to the predetermined time and/or volume, a change in rate of flashing of an indicator light, and serial illumination of a series one or more indicator lights.

Embodiment 83. The method according to any of Embodiments 78-82, wherein the indication of elapsed time after the start time or dispensed volume includes a physical indication.

Embodiment 84. The method according to Embodiment 83, wherein the physical indication includes one or more of vibration and electrical pulse.

Embodiment 85. The method according to any of Embodiments 78-84, wherein the indication of elapsed time after the start time or dispensed volume includes an audio indication.

Embodiment 86. The method according to Embodiment 75, wherein the audio indication includes one or more of a beeping, a buzzing and a clicking.

Embodiment 87. The method according to any of Embodiments 78-86, wherein the actuation of the valve to stop dispensing is performed by the user in response to a stop indication (e.g., one or more of visual stop indication, a physical indication, and/or an audio indication) from the time and/or volume meter.

Embodiment 88. The method according to Embodiment 87, wherein the user releases the trigger to actuate the valve to stop dispensing.

Embodiment 89. The method according to Embodiment 87 or Embodiment 88, wherein the stop indication includes a visual stop indication, e.g., a flashing light (such as the flashing of a display or the flashing of the indicator light), the approach or reaching of a predetermined time and/or volume, or a display of a stop word, icon or signal on a display, or the illumination of a stop light.

Embodiment 90. The method according to any of Embodiments 87-89, wherein the stop indication includes an audible stop indication, e.g., a beeping, a buzzing or a clicking.

Embodiment 91. The method according to any of Embodiments 87-90, wherein the stop indication includes a physical stop indication, e.g., a vibration or a mild electric pulse.

Embodiment 92. The method according to any of Embodiments 78-91, wherein one or more of the indications, for example, visual indications (i.e., including the visual stop indication), the physical indications (i.e., including the visual stop indication) and the audio indications (i.e., including the visual stop indication), is provided by the insulation dispenser.

Embodiment 93. The method according to Embodiment 92, wherein one or more of the indications is provided an electronic display on the insulation dispenser (e.g., a LCD, an LED display, a pixelated display, and/or one or more lights).

Embodiment 94. The method according to Embodiment 92 or Embodiment 93, wherein one or more of the indications is a vibration of or an electric pulse conducted by a part of the insulation dispenser in contact with the user (e.g., a handle being held by the user, or the trigger being held by the user).

Embodiment 95. The method according to any of Embodiments 92-94, wherein one or more of the indications is a sound emitted by the insulation dispenser (e.g., through a speaker or buzzer thereof).

Embodiment 96. The method according to any of Embodiments 78-95, wherein one or more of the indications, for example, visual indications (i.e., including the visual stop indication), the physical indications (i.e., including the visual stop indication) and the audio indications (i.e., including the visual stop indication), is provided by an indicator device remote from the insulation dispenser.

Embodiment 97. The method according to Embodiment 96, wherein the indicator device is in wireless communication with the time and/or volume meter.

Embodiment 98. The method according to Embodiment 96, wherein the indicator device is in wired communication with the time and/or volume meter.

Embodiment 99. The method according to Embodiment 96, wherein the indicator device is part of the time and/or volume meter.

Embodiment 100. The method according to any of Embodiments 96-99, wherein one or more of the indications is provided by an electronic display on the indicator device (e.g., a LCD, an LED display, a pixelated display, and/or a series of lights).

Embodiment 101. The method according to any of Embodiments 96-100, wherein one or more of the physical indications is a vibration of or an electric pulse conducted by a part of the indicator device in contact with the user.

Embodiment 102. The method according to any of Embodiments 96-101, wherein one or more of the audio indications is a sound emitted by the indicator device (e.g., through a speaker or buzzer of the indicator device, such as an earpiece in the ear of the user).

Embodiment 103. The method according to any of Embodiments 78-86 and 92-102, wherein the actuation of the valve to stop dispensing is performed by a valve controller (e.g., of the insulation dispenser) in response to a signal from the time and/or volume meter.

Embodiment 104. The method according to any of Embodiments 78-103, further comprising, before actuating the valve of the insulation dispenser to begin dispensing the one or more precursors of the expanding foam insulation material, encoding (e.g., by the user) the time and/or volume meter with the predetermined time and/or predetermined volume.

Embodiment 105. The method according to any of Embodiments 78-104, wherein the actuation to begin dispensing fixes a start time of a time meter; and the actuation to stop dispensing is performed when a predetermined time after the start time elapses (e.g., within 20 seconds before or after elapsing, e.g., with 10 seconds or within 5 seconds).

Embodiment 106. The method according to Embodiment 105, wherein the actuation to begin dispensing fixes a start time of a time meter; the actuation to stop dispensing is performed in response to a stop indication (e.g., within 20 seconds after the stop indication, e.g., with 10 seconds or within 5 seconds).

Embodiment 107. The method according to Embodiment 105 or Embodiment 106, further comprising determining a dispense rate of the insulation dispenser relating expanded foam volume to dispense time.

Embodiment 108. The method according to any of Embodiments 78-107, wherein the actuation to begin dispensing fixes a zero volume of a volume meter; and the actuation to stop dispensing is performed when a predetermined volume has been dispensed (e.g., within 10%, within 5%, or within 2% of the predetermined volume).

Embodiment 109. The method according to Embodiment 108, wherein the actuation to stop dispensing is performed in response to a stop indication (e.g., within 20 seconds after the stop indication, e.g., with 10 seconds or within 5 seconds).

Embodiment 110. The method according to Embodiment 108 or Embodiment 109, wherein one or more flow sensors measure the flow of the one or more precursors through the insulation dispenser, the flow sensors providing flow information to the volume meter.

Embodiment 111. The method according to any of Embodiments 107-110, further comprising determining a dispense rate of the insulation dispenser relating expanded foam volume to dispense volume of the one or more precursors or dispense volume of an expanding foam insulation material.

Embodiment 112. The method according to any of Embodiments 78-111, further comprising displaying to the user usage data with respect to the expanding foam insulation material or one or more precursors thereof.

Embodiment 113. The method according to Embodiment 112, wherein the usage data provides the amount of material left in one or more containers from which the one or more of the precursors is supplied to the insulation dispenser.

Embodiment 114. The method according to Embodiment 112 or Embodiment 113, wherein the usage data provides the amount of the one or more precursors dispensed and/or the corresponding amount of expanding foam insulation material or expanded foam insulation material since a preselected zero time.

Embodiment 115. The method according any of Embodiments 112-114, wherein the usage data is configured to provide a source change notification when a container from which one or more of the one or more precursors is supplied is nearly empty (e.g., at a preselected fill level that is no more than 20%, no more than 10%, or even no more than 5%).

Embodiment 116. The method according to any of Embodiments 112-115, wherein the usage data is determined at least in part based on a measured dispense time.

Embodiment 117. The method according to any of Embodiments 112-116, wherein the usage data is determined at least in part based on a weight measurement of a container from which one or more of the one or more precursors is supplied.

Embodiment 118. The method according to any of Embodiments 112-117, wherein the usage data is determined at least in part based on flow measurements from one or more flow meters configured to measure the flow of the one or more precursors.

Embodiment 119. The method according to any of Embodiments 78-118, wherein the user inputs the predetermined time and/or predetermined volume to the time and/or volume meter.

Embodiment 120. The method according to any of Embodiments 78-119, wherein the time and/or volume meter determines the predetermined time and/or volume based at least in part on user input (e.g., one or more of size of cavity, volume of cavity, type of expanding foam insulation material being dispensed), optionally together with information provided by the system itself (e.g., measured temperature, measured flow rate).

Embodiment 121. A kit for the use of an expanding insulating foam according to any of Embodiments 1-69, the kit including a plurality of containers (e.g., two), each container including one or more components of the expanding foam insulation but neither container containing all the components of the expanding foam insulation.

Embodiment 122. The kit according to Embodiment 121, wherein a first container contains polyol components of the expanding insulating foam but does not contain any isocyanate components of the expanding insulating foam, and a second container contains isocyanate components of the expanding insulating foam but does not contain any polyol/polyamine components of the expanding insulating foam.

Embodiment 123. A method for producing an expanding insulating foam according to any of Embodiments 1-69, comprising mixing together a plurality of streams of material, at least one stream from each of the plurality of containers of the kit of any of Embodiments 121 and 122.

It will be apparent to those skilled in the art that various modifications and variations can be made to the processes and apparatuses described here without departing from the scope of the disclosure. Thus, it is intended that the present disclosure cover such modifications and variations of this invention provided they come within the scope of the appended claims and their equivalents.

What is claimed is:

1-25. (canceled)

26. An expanding foam insulation material, the expanding foam insulation material being dispensable and expandable to provide an expanded foam insulation material, wherein
(a) the expanding foam insulation material is a polymerizable composition comprising at least one polyol and at least one polyisocyanate, and the expanded foam insulation material is a polyurethane;
(b) the expanding foam insulation material is a polymerizable composition comprising at least one polyamine and at least one polyisocyanate, and the expanded foam insulation material is a polyurea; or
(c) the expanding foam insulation material is a polymerizable composition comprising at least one polyol, at least one polyamine and at least one polyisocyanate, and the expanded foam insulation material is a mixed polyurethane/polyurea; and
(i) the polyisocyanate component has a polyisocyanate functionality of no more than 2.6;
(ii) the polyol and/or polyamine component has a polyol and/or polyamine functionality of no more than 3.5; and/or
(iii) the iso index of the polymerizable composition is no more than 200.

27. The expanding foam insulation material according to claim 26, wherein the polyisocyanate component has a polyisocyanate functionality of no more than 2.5.

28. The expanding foam insulation material according to claim 26, wherein the polyisocyanate component has a polyisocyanate functionality of no more than 2.3.

29. The expanding foam insulation material according to claim 26, wherein the polyol and/or polyamine component has a polyol and/or polyamine functionality of no more than 3.0.

30. The expanding foam insulation material according to claim 26, wherein the polyol and/or polyamine component has a polyol and/or polyamine functionality of no more than 2.4.

31. The expanding foam insulation material according to claim 26, wherein the iso index of the polymerizable composition is no more than 160.

32. The expanding foam insulation material according to claim 26, wherein the iso index of the polymerizable composition is no more than 130.

33. The expanding foam insulation material according to claim 26, wherein the polyisocyanate component has a polyisocyanate functionality of no more than 2.3, and the iso index of the polymerizable composition is no more than 130.

34. The expanding foam insulation material according to claim 26, wherein the polyol and/or polyamine component has a polyol and/or polyamine functionality of no more than 2.4, and the iso index of the polymerizable composition is no more than 130.

35. An expanding foam insulation material according to claim 26, the expanding foam insulation material having a maximum foam height; and no local pressure maximum of more than 500 Pa, wherein for each local pressure maximum in excess of 50 Pa, a time difference between a time of the local pressure maximum and a time of 95% maximum foam height is no more than 80 seconds.

36. An expanding foam insulation material according to claim 26, the expanding foam insulation material having a maximum foam height; for a local pressure maximum after a time of maximum foam height, a time difference between a time of the local pressure maximum and a time of 95% maximum foam height is no more than 80 seconds.

37. The expanding foam insulation material according to claim 26, wherein for a volume of expanded foam insulation material over the range of 1000 cm³ to 100000 cm³, the volume of expanded foam insulation material does not deviate from a linear relationship with the mass of expanding foam insulation material by more than 15%.

38. The expanding foam insulation material according to claim 26, wherein the expanding foam insulation material is a polymerizable composition comprising at least one polyol and at least one polyisocyanate, and the expanded foam insulation material is a polyurethane.

39. The expanding foam insulation material according to claim 26, wherein the polymerizable composition further comprises a blowing agent.

40. The expanding foam insulation material according to claim 26, wherein the expanded foam insulation material has a flame spread less than 25 at a thickness of 4″ as measured by ASTM E84 and a smoke index less than 450 at a thickness of 4″ as measured by ASTM E84.

41. The expanding foam insulation material according to claim 40, wherein the expanding foam insulation further includes one or more particulate fire retardants selected from melamine polyphosphate, ammonium polyphosphate, and expandable graphite.

42. The expanding foam insulation material according to claim 41, wherein the expanding foam insulation further includes a hydrophobic silica having an D50 particle size in the range of 10-1000 nm.

43. An expanded foam insulation material that is the cured product of an expanding foam insulation product of claim 26.

44. A method for providing a cavity of a building with an expanded foam insulation, the cavity being enclosed by one or more walls including a first wall, the method comprising
performing one or more dispensing shots, each comprising dispensing an amount of the expanding foam insulation of claim 26 into the cavity; and then allowing the dispensed amount of expanding foam insulation to substantially finish expanding after it is dispensed in the cavity, thereby forming a shot of expanded foam insulation material in the cavity.

45. An expanding foam insulation material, the expanding foam insulation material being dispensable and expandable to provide an expanded foam insulation material, the expanding foam insulation material having a maximum foam height; and no local pressure maximum of more than 500 Pa, wherein for each local pressure maximum in excess of 50 Pa, a time difference between a time of the local pressure maximum and a time of 95% maximum foam height is no more than 80 seconds.
